(19) United States
(12) Patent Application Publication
(10) Pub. No.: US 2003/0220901 A1
(43) Pub. Date: Nov. 27, 2003

(54) Interaction manager

(75) Inventors: Steven R. Carr, San Jose, CA (US); Harry V. Gentilozzi, Marietta, GA (US); Tudor I. Har, Santa Clara, CA (US); Venkatakrishnan Muthuswamy, Cupertino, CA (US)

Correspondence Address: HEWLETT-PACKARD COMPANY, Intellectual Property Administration, P.O. Box 272400, Fort Collins, CO, 80527-2400, US

(73) Assignee: Hewlett-Packard Development Company

(21) Appl. No.: 10/402,283

(22) Filed: Mar. 27, 2003

Related U.S. Application Data
(60) Provisional application No. 60/382,496, filed on May 21, 2002.
(60) Provisional application No. 60/413,186, filed on Sep. 23, 2002.

(51) Int. Cl. G06F 7/00

(52) U.S. Cl. 707/1

(57) ABSTRACT

An interaction manager (IM) is provided which is designed for gathering information associated with customer interactions, loading customer-related data at the beginning of each session, enriching the customer interactions with offers from a rules service, and performing data caching for more efficient customer interaction data retrieval and processing, including caching a session context with the gathered information and customer-related data after each interaction and restoring the session context at the beginning of each interaction. Offers to the customers are based on a comprehensive real-time view of the customer-related data and are augmented by rules and/or data mining, wherein the rules include enterprise rules and/or policies. The data caching includes saving data in denormalized form. The denormalized form is fashioned by taking the data in the normalized form and caching it lined up flatly and serially, end-to-end, in a long record so that it can be quickly retrieved in subsequent interactions and forwarded to the rules service. The long record with the data in denormalized form is cached along with a session identification key for easy association of the data in the denormalized form with a particular session.

### REFERENCE TO PRIOR APPLICATION

This application claims the benefit of and incorporates by reference U.S. Provisional Application Serial No. 60/382,496, titled “IM Template,” filed May 21, 2002, and U.S. Provisional Application Serial No. 60/413,186, also titled “IM Template,” filed Sep. 23, 2002.

### CROSS REFERENCE TO RELATED APPLICATION

This application is related to and incorporates by reference U.S. patent application Ser. No. 09/948,928, filed Sep. 7, 2001, entitled “Enabling a Zero Latency Enterprise”, U.S. patent Ser. No. 09/948,927, filed Sep. 7, 2001, entitled “Architecture, Method and System for Reducing Latency of Business Operations of an Enterprise”, U.S. patent application Ser. No. 10/013,091, filed Dec. 7, 2001, entitled “ZLE Enriched Publish and Subscribe” and U.S. patent application Ser. No. ______ (Attorney Docket No. 200302580-3), filed Mar. 27, 2003, entitled “Interaction Manager Template”.

### BACKGROUND

1. Field

The present invention relates to enterprise-customer interaction management associated with customer relation management (CRM) applications.

2. Background

One of the critical information technology needs of any large organization (hereafter generally referred to as “enterprise”) is maintaining a comprehensive view of its operations and information, preferably in real time. In view of that, its information technology (IT) infrastructure is often configured to allow distribution of valuable information across the enterprise to its groups of information consumers, including remote employees, business partners and customers.

With conventional solutions in place, enterprises have been using some form of enterprise application integration (EAI) platform to integrate and exchange information between software applications. However, with substantial amounts of information located on disparate systems and platforms, information is not necessarily present in the desired form and place. Moreover, the distinctive features of business applications that are tailored to suit the requirements of a particular domain complicate the integration of applications. In addition, new and legacy software applications are often incompatible and their ability to efficiently share information with each other is diminished.

Deficiencies in integration and data sharing are indeed a difficult problem of IT environments for any enterprise. When requiring information for a particular transaction flow that involves several distinct applications, the inability of organizations to operate as one-organ, rather than separate parts creates a challenge in information exchange and results in economic inefficiencies.

Consider for example applications designed for customer relationship management (CRM) in the e-business environment, also referred to as eCRMs. Conventional eCRMs are designed with an interaction manager (IM) for a specific type of business or industry, but they are not designed for facilitating adaptation to other business enterprises. Moreover, traditional eCRM systems are built on top of proprietary databases that do not contain the detailed up-to-date data on customer interactions. These proprietary databases are not designed for large data volumes or high rate of data updates. As a consequence, these solutions are limited in their ability to enrich data presented to customers. Such solutions are typically incapable of gathering and leveraging real-time knowledge for providing offers or promotions that feed on real-time events, including offers and promotions personalized to the customers. Moreover, industry-specific applications supporting these solutions are not easily adaptable to other industries.

### SUMMARY

The present invention provides an interaction manager (IM). The IM is designed for gathering information associated with customer interactions that occur within sessions and for enriching those interactions with offers or recommendations based upon the comprehensive real-time view of customer information, augmented by business rules and/or data mining.

The IM is integrated with a zero latency enterprise (ZLE) Data Store that caches transaction information collected from across the enterprise through its various applications into normalized tables to provide the desired comprehensive view of its operations, customer information, applications and related enterprise data. The ZLE data store is built to scale to the highest data volumes and rates of update. Furthermore, the IM builds a de-normalized cache of customer information for the duration of a session to optimize response times and throughput for interactions. This cache is disk-based and enabling linear scalability of the data store under a shared-nothing architecture.

In operations, there are typically three different classes of interactions: (1) interactions that start a session for a unique customer, and to that end, provide a mechanism to uniquely identify the customer in the ZLE data store; (2) interactions that participate in an existing session that are identified by the session ID; and (3) interactions identified by a cookie. Cookie interactions automatically participate in a current session for the cookie or start a new session. Cookie interactions may provide a known customer ID, e.g., when the customer checks out, after filling up her shopping cart. The IM associates new cookie sessions with past users of the cookie, unless and until a unique customer ID is presented. Sessions are recorded as anonymous when no customer has ever registered with the cookie.

The IM development involves (1) business logic, (2) test driver logic, (3) CORBA deployment logic and (4) Tuxedo deployment logic. These are bound together by a well-defined application interface, independent of the deployment environment, and implemented by the business logic. The IM is preferably developed using object oriented programming techniques (e.g., in C++). In object oriented programming, a class is an object type used as a template for creating objects, and objects created thereby are instances of that class. Objects encapsulate data and subroutines (methods) and are considered semiautonomous in that they enclose data and methods that are private to them. An object interacts with the rest of the program through interfaces that are defined by the object's public (externally callable) methods. Moreover, the program structure can be hierarchical where an instance of a subclass inherits attributes from an instance of a super class. Accordingly, in the IM template context, distinct interaction types are implemented in distinct subclasses inheriting from common super classes. When the IM is deployed into the corresponding environment, each method is exposed either as a Tuxedo service or a method of the CORBA object.

To recap, an interaction manager (IM) is provided in accordance with the purpose of the invention as embodied and broadly described herein. In one embodiment, the IM is designed for gathering information associated with customer interactions, loading customer-related data at the beginning of each session, enriching the customer interactions with offers from a rules service, and performing data caching for more efficient customer interaction data retrieval and processing, including caching a session context with the gathered information and customer-related data after each interaction and restoring the session context at the beginning of each interaction. Offers to the customers are based on a comprehensive real-time view of the customer-related data and are augmented by rules and/or data mining, wherein the rules include enterprise rules and/or policies. The data caching saves data in denormalized form. The denormalized form is fashioned by taking the data in the normalized form and caching it lined up flatly and serially, end-to-end, in a long record so that it can be quickly retrieved in subsequent interactions and forwarded to the rules service. The long record with the data in denormalized form is cached along with a session identification key for easy association of the data in the denormalized form with a particular session. In a second embodiment, the interaction manager is implemented as a program, embodied in a computer readable medium, with instructions for performing the foregoing functions.

In yet another embodiment, the interaction manager (IM) is designed for creating a session record for a session initiated by an interaction with a customer; loading customer data from a corresponding table in an operational data store (ODS) if an identity of the customer is available for the interaction, the session record being fashioned as an anonymous session record if the customer identity is not available and instead a cookie identifies an anonymous customer; passing to a rules service data related to the current and any former interactions associated with the customer when an offer is commensurate with the interaction; inserting data related to the customer, interaction and any offer from the rules service to each corresponding table in the ODS; caching in the ODS the data related to the customer, interaction and any offer; providing to the customer the offer(s) if commensurate with the interaction; and on any subsequent interaction of that session retrieving the cached data and any offers from the ODS, thereby avoiding the need to load data from the corresponding tables in the ODS.

If on any subsequent interaction of an anonymous session the customer provides the customer identity the IM is designed to associate the cookie with the customer. The IM is further designed to then load customer data from a corresponding table in the ODS, if the customer data is available; pass to the rules service data related to the current and any former interaction associated with the customer when an offer is commensurate with the interaction; insert data related to the customer, interaction and any offer from the rules service to each corresponding table in the ODS; caching in the ODS the data related to the customer, interaction and any offer; and provide to the customer the offer(s) if commensurate with the interaction.

Preferably, the data in each of the corresponding tables is in normalized form, and the cached data is in denormalized form fashioned as a long record that is cached along with a session key for easier association of the long record with the session. Fashioning the long record includes taking the data in the normalized form and caching it lined up flatly and serially, end-to-end, so that it can be quickly retrieved in subsequent interactions and forwarded to the rules service. To meet physical limitations the long record is divided into portions, and the data in denormalized form within each portion of the long record is cached along with a session identification key for easy association of the portions with the session.

Additionally, since the ODS is typically configured as a plurality of storage devices, the corresponding tables are partitioned by dividing each table into partitions and distributing the partitions of each table among the storage devices, one partition for each storage device. Preferably, the corresponding tables are partitioned evenly so as to allow load balancing among the storage devices. Notably, there is a partition ID associated with each partition identifying the storage device that houses that partition.

It is further noted that each created session record has a key with a number of fields, one field contains the partition ID of the partition to the end of which the created session record is appended, a second field contains session date and a third field contains session identification. Preferably, the session identification is a number assigned to each session in ascending order.

Advantages of the invention will be understood by those skilled in the art, in part, from the description that follows. Advantages of the invention will be realized and attained from practice of the invention disclosed herein.

### BRIEF DESCRIPTION OF THE DRAWINGS

The accompanying drawings, which are incorporated in and constitute a part of this specification, illustrate several embodiments of the invention and together with the description, serve to explain the principles of the invention. Wherever convenient, the same reference numbers will be used throughout the drawings to refer to the same or like elements.

FIG. 1 illustrates a ZLE framework that defines, in the preferred embodiment, a multilevel architecture (ZLE architecture) centered on a virtual hub.

FIG. 2 illustrates the core of the ZLE framework.

FIG. 3 illustrates a ZLE framework with an application server supporting ZLE core services that are based on Tuxedo, CORBA or Java technologies.

FIG. 4 illustrates a ZLE framework configured for publish and subscribe operations

FIG. 5 illustrates the enriched publish and subscribe operations.

FIG. 6 illustrates the elements of interaction management in the eCRM example.

FIGS. 7a-c illustrate interaction manager (IM) operations at the start of a new session, upon resuming a session and on changing a customer during a browse (cookie) session.

FIGS. 8a-f further illustrate IM operations, including inserting new session records, loading customer data, getting offers, inserting records, caching session data.

FIG. 9 demonstrates the business rules based for example of demographic information.

FIGS. 10a-c show the data types in the operational data store (ODS): event, lookup and state.

FIG. 11 is a diagram showing deployment server classes including the IM and key manager for the eCRM example.

FIG. 12 shows the ZLE schema of a session key.

FIGS. 13a-d show key management schemas for various table types.

### DETAILED DESCRIPTION

Servers, such as Hewlett-Packard's NonStop™ servers, host various mission-critical applications for enterprises around the world. One such mission-critical application is directed to customer-relations management (CRM). In view of that, the present invention relates to interaction management associated with CRMs, including CRMs in the e-business environment (eCRMs). In this context, the interaction manager (IM) is an enterprise application that captures interactions with enterprise ‘customers’, gathers customers' data, calls upon a rules service to obtain offers customized for such customers and passes the offers to these customers.

The design of a representative system embodying an interaction manager targets the maintenance of a comprehensive real-time view of enterprise operations and information. By configuring the system on an information technology (IT) platform with a framework that enables the enterprise to integrate its services, applications and data in real time, the enterprise can function as a zero latency enterprise (ZLE) and achieve enterprise-wide real-time view of its operations. Based on this platform, the present invention introduces an IM that utilizes data caching for more efficient customer-interaction data retrieval and processing. In addition to providing mechanisms for loading customer-related data at the beginning of each session, the IM provides mechanism for caching session context (including customer data) after each interaction and for restoring session context at the beginning of each interaction. What is more, the IM takes normalized data and denormalizes it, caching it lined up flatly end-to-end to form one long (serialized) record, so that it can be quickly retrieved in subsequent interactions and forwarded to the rules service. Along with the denormalized data, each long record is cached containing a session ID key (for easy association of the denormalized data with the particular session).

To enable one of ordinary skill in the art to make and use the invention, the description of the invention is presented herein in the context of a patent application and its requirements. Although the invention will be described in accordance with the shown embodiments, one of ordinary skill in the art will readily recognize that there could be variations to the embodiments and those variations would be within the scope and spirit of the invention.

I. Zero Latency Enterprise (ZLE) Overview

In the preferred embodiment, the interaction manager operates in the context of an information technology (IT) infrastructure that enables an enterprise to run as zero latency enterprise (ZLE). Thus, as a preferred functional and architectural strategy, the interaction manager (IM) will be embodied in the ZLE framework. Namely, the IM is implemented as part of the scheme for reducing latencies in enterprise operations. This scheme enables the enterprise to integrate its services, business rules, business processes, applications and data in real time. In other words, it enables the enterprise to run as a ZLE.

A. The ZLE Concept

In integrating e-commerce into their business models enterprises have had to deal with the shortcomings of latencies in their operations, including their interaction with and responses to consumers. Zero latency allows an enterprise to achieve coherent operations, efficient economics and competitive advantage.

Notably, what is true for a single system is also true for an enterprise—reduce latency to zero and you have an instant response. An enterprise running as a ZLE, can achieve enterprise-wide recognition and capturing of business events that can immediately trigger appropriate actions across all other parts of the enterprise and beyond. Along the way, the enterprise can gain real-time access to a real-time, consolidated view of the its operations and data from anywhere across the enterprise. As a result, the enterprise can apply business rules and policies consistently across the enterprise including all its products, services, and customer interaction channels. As a further result, the entire enterprise can reduce or eliminate operational inconsistencies, and become more responsive and competitive via a unified, up-to-the-second view of customer interactions with any part(s) of the enterprise, their transactions, and their behavior. Moreover an enterprise running as a ZLE and using its feedback mechanism can conduct instant, personalized marketing scored and fine-tuned in real time while the customer is engaged. This result is possible because of the real-time access to the customer's profile and enterprise-wide rules and policies (while interacting with the customer). What is more, an enterprise running as a ZLE achieves faster time to market for new products and services, reduced exposure to fraud, customer attrition, and other business risks. In addition, an enterprise running as a ZLE has the tools for managing its rapidly evolving resources (e.g., workforce) and business processes.

B. The ZLE Framework and Architecture

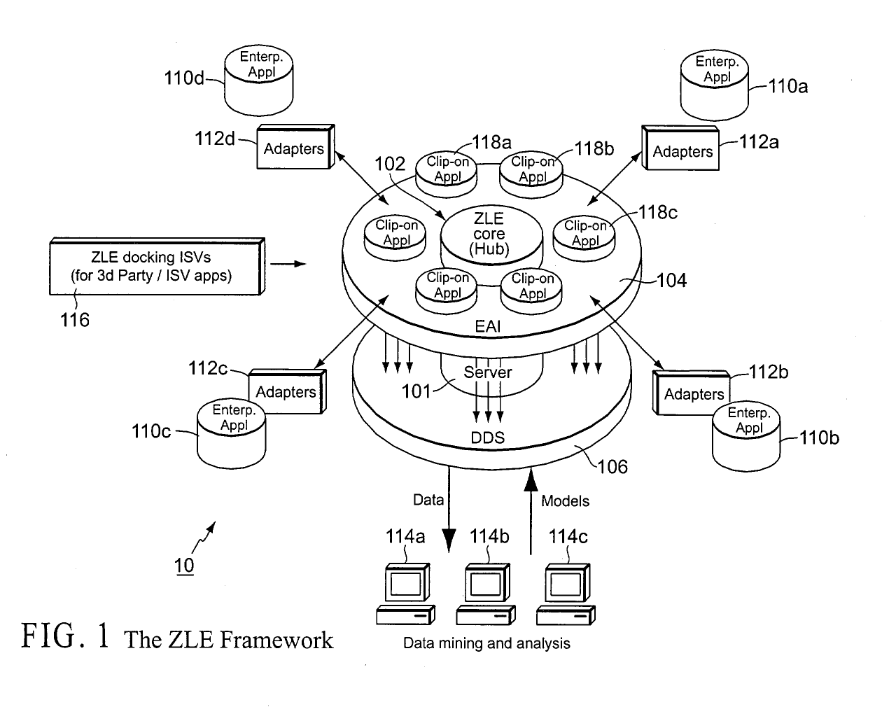

To become a zero latency enterprise, an enterprise integrates, in real time, its business processes, applications, data and services. Zero latency involves real-time recognition of business events (including interactions), and simultaneously synchronizing and routing information related to such events across the enterprise (as shown in FIG. 15a). As a means to that end, the aforementioned enterprise-wide integration for enabling the ZLE is implemented in a framework, the ZLE framework. FIG. 1 illustrates a ZLE framework.

As shown, the ZLE framework 10 defines a multilevel architecture, the ZLE architecture. This multilevel architecture provides much more than an integration platform with enterprise application integration (EAI) technologies, although it integrates applications and data across an enterprise; and it provides more comprehensive functionality than mere real time data warehousing, although it supports data marts and business intelligence functions. As a basic strategy, the ZLE framework is fashioned with hybrid functionality for synchronizing, routing, and caching, related data and business intelligence and for transacting enterprise business in real time. With this functionality it is possible to conduct live transactions against the ODS. For instance, the ZLE framework aggregates data through an operational data store (ODS) 106 and, backed by the ODS, the ZLE framework integrates applications, propagates events and routes information across the applications through the EAI 104. In addition, the ZLE framework executes transactions in a server 101 backed by the ODS 106 and enables integration of new applications via the EAI 104 backed by the ODS 106. Furthermore, the ZLE framework supports its feedback functionality via the data mining and analysis 114 and reporting mechanism (which are also backed by the ODS). Advantageously, the ZLE framework 10 is extensible in order to allow new capabilities and services to be added. Thus, the ZLE framework enables coherent operations and reduction of operational latencies in the enterprise.

The preferred ZLE framework 10 defines a ZLE architecture that serves as a robust system platform capable of providing the processing performance, extensibility, and availability appropriate for a business-critical operational system. The multilevel ZLE architecture is centered on a virtual hub, called the ZLE core (or ZLE hub) 102. The enterprise data caching functionality (ODS) 106 of the ZLE core 102 is depicted on the bottom and its EAI functionality 104 is depicted on the top. Data mining and analysis applications 114 pull data from the ODS 106 at ZLE core 102 and contribute result models to it. The result models can be used to drive new business rules, actions, interaction management and so on. Although the data mining and analysis applications 114 are shown residing with systems external to the ZLE core, they can alternatively reside with the ZLE core 102. Clip-on applications 108, including the IM, are tightly coupled to the ZLE core 102 residing on top of the ZLE core and directly accessing its services. Enterprise applications 110, such as SAP's enterprise resource planing (ERP) application or Siebel's customer relations management (CRM) application, are loosely coupled to the ZLE core (or hub) 102 being logically arranged around the ZLE core and interfacing with it via application or technology adapters 112. The docking of ISV (independent solution vendors) solutions such as the enterprise applications 110 is made possible with the ZLE docking 116 capability. The ZLE framework's open architecture enables core services and plug-in applications to be based on best-of-breed solutions from leading ISVs. This, in turn, ensures the strongest possible support for the full range of data, messaging, and hybrid demands.

1. The ZLE Core

The ZLE core is a virtual hub for applications that can clip on to it and be served by its native services. Any specialized applications—including those that provide new kinds of solutions that depend on ZLE services, e.g., IM—can clip on to the ZLE core. The ZLE core is also a hub for data mining and analysis applications that draw data from and feed result-models back to the ZLE core. Indeed, the ZLE framework combines the EAI, ODS, OLTP (on-line transaction processing), data mining and analysis, automatic modeling and feedback, thus forming the touchstone hybrid functionality of every ZLE framework. To this functionality others can be added including the functionality of native and core ISV services and of clip-on and enterprise applications. Moreover, the ZLE core enables an array of enterprise applications (third party application) to interface to and become part of the ZLE framework.

The ZLE core components include an ODS acting as a central repository with cluster-aware RDBMS functionality, a transactions application server acting as a robust hosting environment for integration services and clip-on applications, and core services. These components are not only integrated, but the ZLE core is designed to derive maximum synergy from this integration. Furthermore, the services at the core of ZLE optimize the ability to integrate tightly with and leverage the ZLE architecture, enabling a best-of-breed strategy. They contribute essential ZLE services that enable a true Compaq ZLE™.

It is noted that Hewlett-Packard®, Compaq®, Compaq ZLE™, NonStop™, AlphaServer™, True64™, and the Hewlett-Packard and Compaq logos, are trademarks of the Hewlett-Packard Company. UNIX® is a trademark of the Open Group. Any other product names may be the trademarks of their respective originators.

2. ZLE Core Services

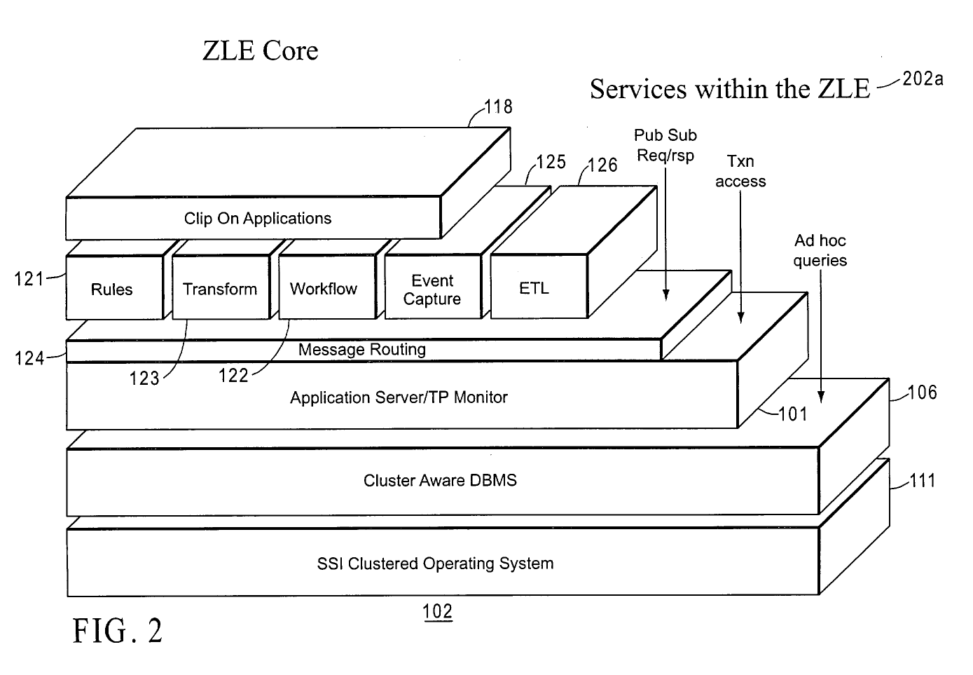

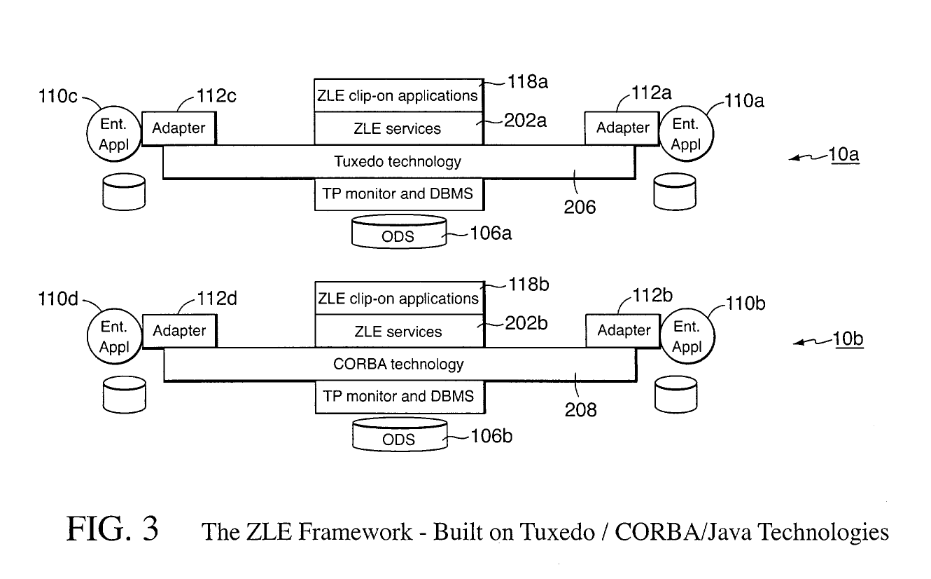

At the ZLE core of the ZLE framework resides a set of ZLE service—i.e., core services and capabilities—as shown in FIGS. 2 and 3. The core services 202 can be fashioned as native services and core ISV services (ISVs are third-party enterprise software vendors). The ZLE services (121-126) are preferably built on top of an application server environment founded on Tuxedo 206, CORBA 208 or Java technologies (CORBA stands for common object request broker architecture). The broad range of core services includes business rules, message transformation, workflow, and bulk data extraction services; and, many of them are derived from best-of-breed core ISVs services provided by Compaq, the originator of the ZLE framework, or its ISVs.

Among these core services, the rules service (121) is provided for event-driven enterprise-wide business rules and policies creation, analysis and enforcement. The rules service itself is a stateless server (or context-free server). It is not keeping track of the current state for any request. Incidentally, the rules service does not need to be implemented as a process pair because it is stateless, and a process pair is used only for a stateful server. It is just a server class so any instance of the server class can process it. Implemented using Blaze Advisor, the rules service enables writing business rules using graphical user interface or syntax like a declarative, English-language sentence. Additionally, in cooperation with the interaction manager, the rules service is designed to find and apply the most applicable business rule upon the occurrence of an event. Based on that, the rules service is designed to arrive at the desired data (or answer) which is uniform throughout the entire enterprise. Hence this service may be referred to as the uniform rules service. This service allows the ZLE framework to provide a uniform rule-driven environment for flow of information and supports its feedback mechanism (through the IM). The rules service can be used by the other services within the ZLE core, and any clip-on and enterprise applications that an enterprise may add, for providing enterprise-wide uniform treatment of business rules and transactions based on enterprise-wide uniform rules.

The extraction, transformation, and load (ETL) service (126) enables large volumes of data to be transformed and moved quickly and reliably in and out of the database (often across databases and platform boundaries). The data is moved for use by analysis or operational systems as well as by clip-on applications.

The message transformation service (123) maps differences in message syntax, semantics, and values, and it assimilates diverse data from multiple diverse sources for distribution to multiple diverse destinations. The message transformation service enables content transformation and content-based routing, thus reducing the time, cost, and effort associated with building and maintaining application interfaces.

The workflow (process flow) service 122 is provided for supporting global business transactions across multiple systems, and for mapping and controlling the flow of short or long term business transactions across the enterprise. The workflow (or process-flow) service manages the flow of business transactions and processes between multiple systems and applications that are integrated via the ZLE framework and may take only seconds or up to days to execute. This entails monitoring and managing ongoing transactions as well as ensuring the correct flow of business transactions. The workflow service leverages the state engine capabilities of the ZLE core database to track the state of the transaction—and provide visibility into its progress—over the ensuing hours, days, and weeks it takes to run its course.

The parallel message router and inserter service (124) is provided for high performance, high-volume routing, and insertion of transaction event data into the ODS and other ZLE services and applications. Message routing may involve the rules and workflow services of the ZLE core. These services may intervene to determine where particular messages are to be routed based on content and predefined workflow process. A powerful message routing and insertion capability is designed for routing high volumes of messages through the ZLE architecture. To propagate high volumes of messages to the database and elsewhere within the ZLE framework, the router and inserter function leverages the parallelism of the ZLE platform. This capability can further include content-based routing and use of the ODS as a database management system that can store transactions in SQL tables and as a centralized message store and queuing system for efficient publish/subscribe message distribution. Constantly refreshed information, such as stock prices or data on inventory levels, can be inserted into the ODS and then published to the appropriate subscriber.

Essentially, this message routing and insertion capability is routing between the internal components of the ZLE core. Hence, although the ZLE framework supports message oriented middleware (MOM), this capability differs from the functionality of routing and queuing systems that move messages from application to application.

3. Server Platform

Fundamentally, the ZLE framework includes elements that are modeled after a transaction processing (TP) system. In broad terms, a TP system includes application execution and transaction processing capability, one or more databases, tools and utilities, networking functionality, an operating system and a collection of services that include TP monitoring. A key component of any TP system is a server. The server is capable of parallel processing, and it supports concurrent TP, TP monitoring and management of transactions-flow through the TP system. The application server environment advantageously can provide a common, standard-based framework for interfacing with the various ZLE services and applications as well as ensuring transactional integrity and system performance (including scalability and availability of services). Thus, the ZLE services (121-126) are executed on a server, preferably a clustered server platforms 101 such as the Hewlett-Packard (Compaq) NonStop™. These clustered server platforms 101 provide the parallel performance, extensibility (e.g., scalability), and availability requisite for business-critical operations.

In one configuration, the ODS is embodied in the storage disks within such server system. NonStop™ server systems are highly integrated fault tolerant systems and do not use externally attached storage. The typical NonStop™ server system will have hundreds of individual storage disks housed in the same cabinets along with the CPUs, all connected via a server net fabric. Although all of the CPUs have direct connections to the disks (via a disk controller), at any given time a disk is accessed by only one CPU (one CPU is primary, another CPU is backup). One can deploy a very large ZLE infrastructure with one NonStop™ serve node. In one example the ZLE infrastructure is deployed with 4 server nodes. In another example, the ZLE infrastructure is deployed with 8 NonStop™ server nodes.

It is noted that in the present configuration the data mine is set up on a Windows NT or a Unix system because present (data mining) products like SAS' are not suitable for running directly on the NonStop™ server systems. SAS is a third party application specializing in data mining. The Genus Mart Builder is a component pertaining to the data preparation where aggregates are collected and moved and down into SAS. Future configurations with a data mine may use different platforms as they become compatible.

4. Clip-on Applications

Clip-on applications 118, literally clip on to, or are tightly coupled with, the ZLE core 102. They are not standalone applications in that they require the substructure of the ZLE core and its services (e.g., native core services) in order to deliver highly focused, business-level functionality of the enterprise. Clip-on applications, provide business-level functionality that leverages the ZLE core's real-time environment and application integration capabilities and customizes it for specific purposes. ISVs (such as Trillium, Recognition Systems, and MicroStrategy) as well as the originator of the ZLE framework (Hewlett-Packard Corporation, formerly Compaq Computer Corporation) can contribute value-added clip-on applications such as for fraud detection, customer interaction and personalization, customer data management, narrowcasting notable events, and so on. A major benefit of clip-on applications is that they enable enterprises to supplement or update its ZLE core native or core ISV services by quickly implementing new services. Examples of clip-on applications include the interaction manager, narrowcaster, campaign manager, customer data manager, and more. The following describes these examples in some detail.

The interaction manager (IM) application (by Hewlett-Packard Corporation) leverages the rules engine 121 within the ZLE core to define complex rules governing customer interactions across multiple channels. The IM also adds a real-time capability for inserting and tracking each customer transaction as it occurs so that relevant values and more can be offered to consumers based on real-time information. More details on the IM will be provided later in this description.

The narrowcaster application preferably uses MicroStrategy software that runs against the relational database of the ODS in order to notify a notable event (hence it is also called notification application). Notable events are detected within the ZLE framework in real-time. Then, sharing data (in the ODS) that the IM and rules engine have used to assert the notable event, the narrowcaster selectively disseminates a notification related to such events. The notification is narrowcasted rather than broadcasted (i.e., selectively disseminates) to terminals, phones, pagers, and so on of specific systems, individuals or entities in or associated with the enterprise.

The campaign manager application can operate in a recognition system such as the data mining and analysis system (114, FIG. 1) to leverage the huge volumes of constantly refreshed data in the ODS of the ZLE core. The campaign manger directs and fine-tunes campaigns in real time based on real-time information gathered in the ODS.

The customer data manager application leverages customer data management software to synchronize, delete, duplicate and cleanse customer information across legacy systems and the ODS at the ZLE core in order to create a unified and correct customer view.

5. Extending ZLE via Enterprise Applications and Adapters

The ZLE core architecture is designed to evolve with changes in the business environment of the enterprise. Enterprise applications (typically specialized ISV solutions), such as PeopleSoft, SAP's ERP or Siebel's CRM applications, can “dock” on the ZLE core via adapters. The adapters enable normalized messaging for exchanges among standard applications (such as SAP, PeopleSoft, popular Web server applications, and so on) as well as exchanges with custom applications. There are other architectural and functional requirements that the adapters support, including allowing, for example, legacy environments and diverse databases to join the ZLE framework.

Enterprise applications are loosely coupled to the ZLE core, the clip-on applications and other third party enterprise application (or ISV solutions). When so interfaced, an enterprise application becomes a logical part of the ZLE framework and shares that data with all the other applications through its ZLE data store (ODS). Enterprise applications differ from the tightly coupled clip-on applications in that they can stand alone, without the benefit of the ZLE framework. However, their value to the enterprise is increased immensely by integration with the ZLE framework. In some cases, these applications are the “end-consumers” of the ZLE architecture. In others, they provide much of its fodder in the form of information and specialized procedures of the enterprise. Typically, as enterprise applications integrate or interface via the ZLE framework with other applications and systems across the enterprise they play both roles—i.e., taking and providing information in real time. Notably, the information applications take and provide is centrally warehoused in the ODS, more details of which are hereafter provided.

6. Operational Data Store (ODS) with Cluster-Aware RDBMS Functionality

The ODS with its relational database management system (RDBMS) functionality is integral to the ZLE core and central to achieving the hybrid functionality of the ZLE framework (106 FIG. 1). The ODS 106 provides the mechanism for dynamically integrating data into the central repository or data store for data mining and analysis, and it includes the cluster-aware RDBMS functionality for handling periodic queries and for providing message store functionality and the functionality of a state engine. Being based on a scalable database, the ODS is capable of performing a mixed workload. The ODS consolidates data from across the enterprise in real time and supports transactional access to up-to-the-second data from multiple systems and applications, including making real-time data available to data marts and business intelligence applications for real-time analysis and feedback. For the purpose of publish and subscribe as will be further detailed below, the ODS is managed using database extractors and database loaders technologies.

As part of this scheme, the RDBMS is optimized for massive real-time transaction and loads, real-time queries, and batch-extraction. The cluster-aware RDBMS is able to support the functions of an ODS containing current-valued, subject-oriented, and integrated data reflecting the current state of the systems that feed it. As mentioned, the preferred RDBMS can also function as a message store and a state engine, maintaining information as long as required for access to historical data. It is emphasized that ODS is a dynamic data store and the RDBMS is optimized to support the function of a dynamic ODS.

The cluster-aware RDBMS component of the ZLE core is, in this embodiment, either the NonStop™ SQL database running on the NonStop™ platform or Oracle Parallel Server running on the Tru64 UNIX AlphaServer™ system. In supporting its ODS role of real-time enterprise data cache, the RDBMS contains preferably three types of information: state data, event data and lookup data. State data includes transaction state data or current value information such as a customer's current account balance. Event data includes detailed transaction or interaction level data, such as call records, credit card transactions, Internet or wireless interactions, and so on. Lookup data includes data not modified by transactions or interactions at this instant (i.e., an historic account of prior activity).

Overall, the RDBMS is optimized for application integration as well as real-time transactional data access and updates and queries for business intelligence and analysis. For example, a customer record in the ODS (RDBMS) might be indexed by customer ID (rather than by time, as in a data warehouse) for easy access to a complete customer view. In this embodiment, key functions of the RDBMS includes dynamic data caching, historical or memory data caching, robust message storage, state engine and real-time data warehousing.

The state engine functionality allows the RDBMS to maintain real-time synchronization with the business transactions of the enterprise. The RDBMS state engine function supports workflow management and allows tracking the state of ongoing transactions (such as where a customer's order stands in the shipping process) and so on.

The real-time data warehousing function of the RDBMS supports the real-time data warehousing function of the ODS. This function can be used to provide data to data marts and to data mining and analysis applications.

The dynamic data caching function aggregates, caches and allows real-time access to real-time state data, event data and lookup data from across the enterprise. Advantageously, this function, for example, obviates the need for contacting individual information sources or production systems throughout the enterprise in order to obtain this information. As a result, this function greatly enhances the performance of the ZLE framework.

The historical data caching function allows the ODS to also supply a historic account of events that can be used by newly added enterprise applications (or clip-on applications such as the IM). Typically, the history is measured in months rather than years. The historical data is used for enterprise-critical operations including for transaction recommendations based on customer behavior history.

The state engine functionality allows the RDBMS to maintain real-time synchronization with the business transactions of the enterprise. The state engine function supports workflow management and allows tracking the state of ongoing transactions (such as where a customer's order stands in the shipping process) and so on.

The robust message store function supports the EAI platform for ZLE core-based publish and subscribe operations. Messaging functions in the ZLE framework may involve a simple messaging scenario of an EAI-type request-response situation in which a call-center application requests information on a particular customer from a remote billing application. The call-center application issues a Tuxedo or CORBA call that the transformation service in the ZLE core maps to a Tuxedo call for communicating with the remote application. Billing information flows back to the call center through a messaging infrastructure. Performing publish and subscribe through the relational database enables the messaging function to leverage the parallelism, partitioning, and built-in manageability of the RDBMS platform. This platform supports priority, first-in/first-out, guaranteed, and once-and-only-once delivery. More details about publish and subscribe operations are provided below.

7. Enriched Publish and Subscribe Functionality

In general, publish and subscribe refers respectively to pushing data into and pulling data out of a system. Pushing data involves operations such as allocating, writing, inserting and/or saving data. Pulling data involves operations such as selecting, requesting, reading, and/or extracting data. Puling and pushing data may additionally involve sending and/or receiving the data by means of messages.

In the ZLE context, publish and subscribe operations are responsive to applications that subscribe to the ZLE framework. Subscribing applications ask for specific information whenever certain business events occur (e.g., customer interactions). These applications could be Web server, call center, or fraud detection applications in search of changes in a consumer's credit status; or they could be electronic catalog or supply chain applications dependent on receiving the most current inventory status. When events occur, an adapter publishes the change to the ZLE framework. The appropriate ZLE core service then formats the messages correctly and pushes them to the subscribing applications, where they are filtered through the application adapters.

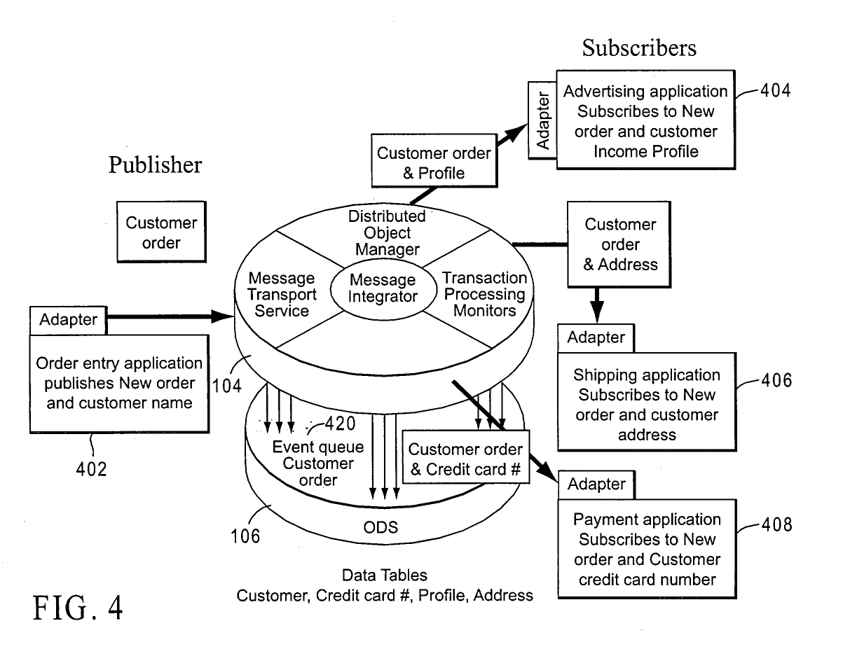

FIG. 4 illustrates the ZLE framework configuration for publish and subscribe operations. In the ZLE framework, ZLE core-based publish and subscribe operations involve EAI tools for performing message functions, while database and application servers are in charge of transaction and data functions. Data related to real-time operations of the enterprise is cached in the ODS using database extractors, database loaders and application adapter technologies to retrieve it. Using these technologies, the ZLE framework synchronizes information across the enterprise using the enriched publish and subscribe operations (supported by the ODS and EAI tools).

As shown, for message publishing (pushing to ODS) and message subscription (pulling from ODS and dissemination), the RDBMS caches and queues messages (420) for subscribers (relating for example to specific events, e.g, customer interactions, and their results). Data can be published by an application (e.g., 402) to the ODS 106 for formatting and insertion into a database table. The data can then be routed out of the ODS to multiple subscriber applications (e.g., 404, 406, 408). In this way, the innate parallelism, scalability, and reliability of the database can be leveraged, along with its management capabilities, to ensure an efficient flow of subscriber messages. Of course, the current information contained in the database tables is also available for ad hoc querying or for bulk shipment to analytic applications, data marts, and so on.

Notably, the ability of the ODS to cache data can be used to enrich the messages that pass through the ZLE framework. Similarly, information cached in the ODS for distribution to subscribers can pick up additional data that has been cached there by other applications. For example, a business-to-business customer wants to make an online purchase. As the ZLE architecture pulls together current inventory and pricing information, it can enrich it with personalized customer-specific data from its data store regarding special offers on related products—information that is invisible to the inventory system.

Although the ZLE framework supports message oriented middleware (MOM), its message routing capability differs from the scheme of routing and queuing messages that are moved from application to application. Indeed, with the ZLE framework the number of information requests to the system (including legacy applications and native core services), can be reduced and the overloading of the legacy system can be avoided.

The ZLE hub can minimize the number of messages by enriching the first message of each new event with the information that the legacy applications need in order to complete their task. The ZLE hub is pre-configured to know what sets of information these applications need as each legacy application identifies the events, type(s) of data changes and associated information in which it is interested. The legacy application then registers this request with a ZLE enriched publish-subscribe service provider module. The ZLE enriched publish-subscribe service provider module stores this pre-configured information request in the operational data store. When a new business event such as a new order arrives at the ZLE, the ZLE hub writes this information into the operational data store. This action in turn triggers an indication that some applications are subscribing to that event.

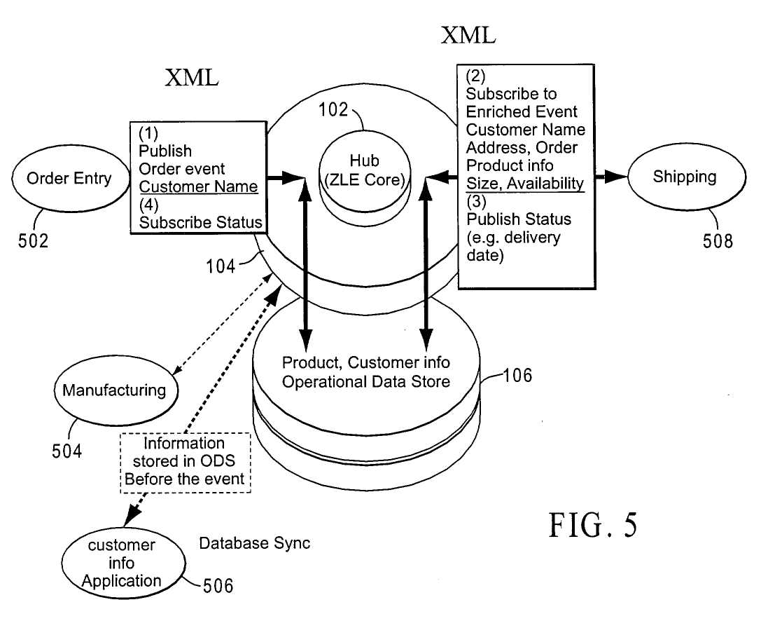

For example, before sending the order message to the shipping application in response to an order event, the ZLE hub enriches the order message with the customer address, product size and availability information (see, e.g., FIG. 5). In this way, the number of messages across the enterprise is reduced to half. Furthermore, there is no load imposed on applications that were not taking part in the transactions. Thus, In an enterprise running as a ZLE, when a business event (e.g., order) arrives at the ZLE hub and a message is sent to the shipping application, the shipping application does not need to create multiple requests and responses to other applications. Rather, it will subscribe or send a message only to the ZLE hub for information about product size and availability. Since the information is already cached in an operational data store (ODS), the ZLE hub is in a position to respond to the request directly. The shipping application then asks the ZLE hub for information about the customer address. The ZLE hub provides that piece of information without the need to also ask another application. As will be explained with reference to the interaction manager (IM), this information is cached in the ZLE hub whenever the customer interacts with the enterprise for the first time or whenever this information is subsequently changed.

With this architecture, the load on legacy applications is drastically reduced since the information is provided directly from the ODS at the ZLE hub and not from the legacy applications. The legacy applications update the information at the ODS on their own time, and only when some of the information in their environment changes, such as when a customer calls to change a home address.

In sum an enterprise equipped to run as a ZLE is capable of integrating, in real time, its enterprise-wide data, applications, business transactions, operations and values. Consequently, an enterprise conducting its business as a ZLE exhibits superior management of its resources, operations, supply chain and customer care.

II. ZLE Development Kit (ZDK)

In one embodiment, an interaction manager (IM) deployment template is provided in the ZDK (ZLE development kit), which is the tool kit that creates ZLE applications such as the IM (these applications are referred to above “the clip-on applications”). Although later versions of ZDK, e.g. ZDK2, are more suited for embodying the present invention, for simplicity we refer to them in general as “ZDK” to simplify the discussion.

Notably, the ZDK includes an IM deployment template for creating the IM. Although the rules service template for creating the rules service will not be discussed here, in some instances one might want to think of the IM deployment template as broadly encompassing both of those templates. For each template, there is an application deployment user guide with step-by-step instructions for completing the particular application. The IM template supports both Tuxedo and CORBA deployment to allow applications and services to run on top of CORBA or on top of Tuxedo (although other platforms can be supported as well).

Incidentally, to create the deployment template for the IM it was necessary to Refactor the IM. Refactoring is a term used in object oriented programming to describe code restructuring technique to effect program transformation. With object oriented programming, as the classes are redesigned, methods have to be moved from one class to another class where they have better cohesion with the other methods of that class or the properties of that class (as opposed to merely making them visible from one class to another; especially if there is a poor object design with too many links, and all classes are pointing (referring) to all the other classes. By Refactoring, things are moved around to refine the design. The IM had to be Refactored in order to make it into a template because, initially, much of the business specific logic and reusable objects were scattered all over the place.

In the ZDK, each template provides a framework of wizards that generate code frames. Additional wizards are provided with the ZDK so as to allow incremental addition of functionality to applications such as the IM. Wizards are framed as scripts (a list of commands) that are used to generate the code frames. Perl (practical extraction and reporting language) is a cross platform scripting language that is preferably used in fashioning the wizards. Perl scripts are typically plain text files made up of Perl statements and Perl declarations. The scripts are not interactive hence the wizards are not interactive. The wizards are invoked by calling a file or directly from a command line. When the Perl command is used to run the scripts with the Perl interpreter the command looks for the script(s) line-by-line or in a file named in the command line.

In addition, the ZDK includes example applications that were built from the templates. An example will typically include more than one application built from more than one template, and although the templates are generic the example is industry specific. In one embodiment, the ZDK includes two example of IM built from the IM template (the ATM and eCRM examples). These examples can help one understand how the IM template works and what a completed IM looks like.

The ATM example is based on the scenario of an ATM (automated teller machine) controller. In this example the customer is unambiguously identifiable via an ATM card number supplied at the start of the session, within the InsertCard interaction type. This interaction returns a new session ID. The other interaction types require the client to supply this session ID within the request interactions CheckBalance and WithdrawCash.

The eCRM example is based on the scenario of an online store. It illustrates the identification of sessions by cookies as it allows the guest to be anonymous or obscurely identified. It includes interaction types such as BrowseItem and AccountMaint.

Incidentally, the ZDK includes examples of services such as customer management, data cleansing and data enrichment services (used in eCRM context). For example, a CRM application may be required to display some interaction history and for that it interfaces with the customer manager. The customer manager pulls out that history and hands it back to the CRM application. This information is available to the customer manager (at the ODS), but the customer manager owns the customer information. Now and then it also uses data cleansing server class (e.g., Trillium) and data enrichment server class (Acxiom).

III. Interaction Manager

A. Overview

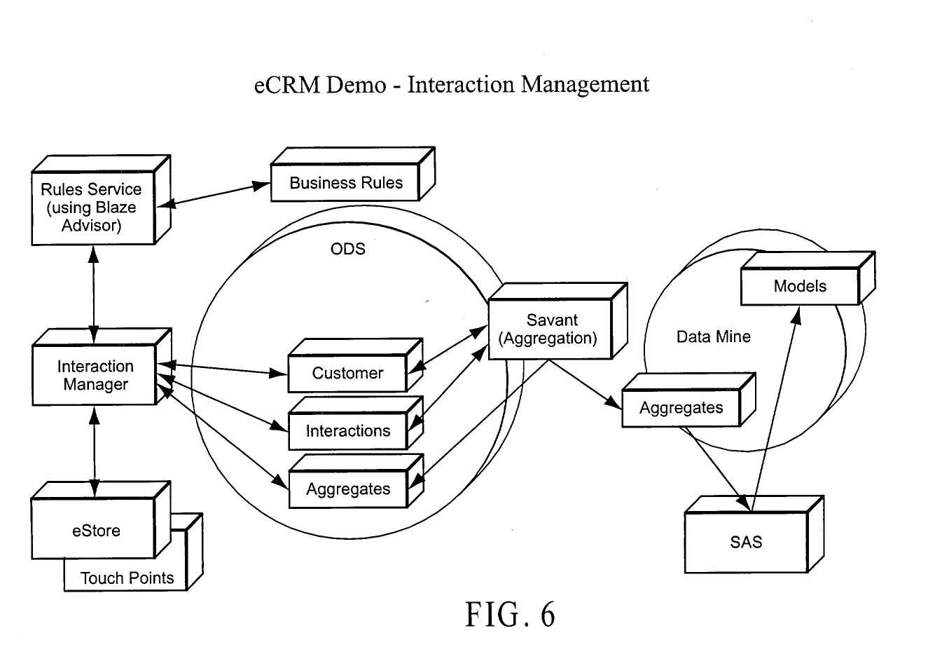

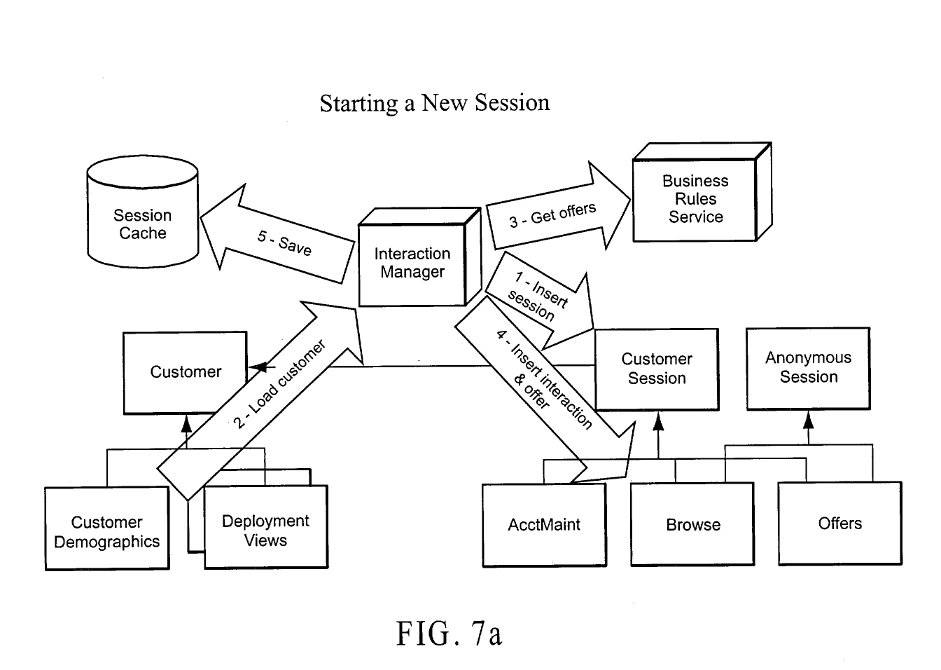

The interaction manager (IM) application is created from the IM template (in a manner as will be later explained). An example of IM deployed for eCRM is shown in FIG. 6. The IM interacts with the other ZLE components via the ODS. As noted above, the IM application leverages the rules engine within the ZLE core to define complex rules governing customer interactions across multiple channels. The IM also adds a real-time capability for inserting and tracking each customer transaction as it occurs, so that relevant offers could be made to consumers based on real-time information. The IM is a scalable stateless server class that maintains an unlimited number of concurrent customer sessions.

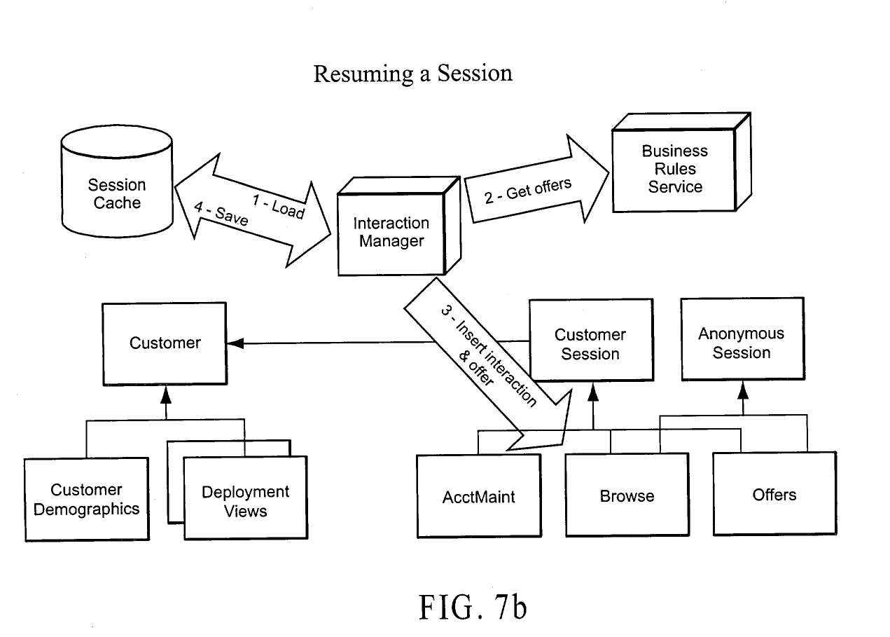

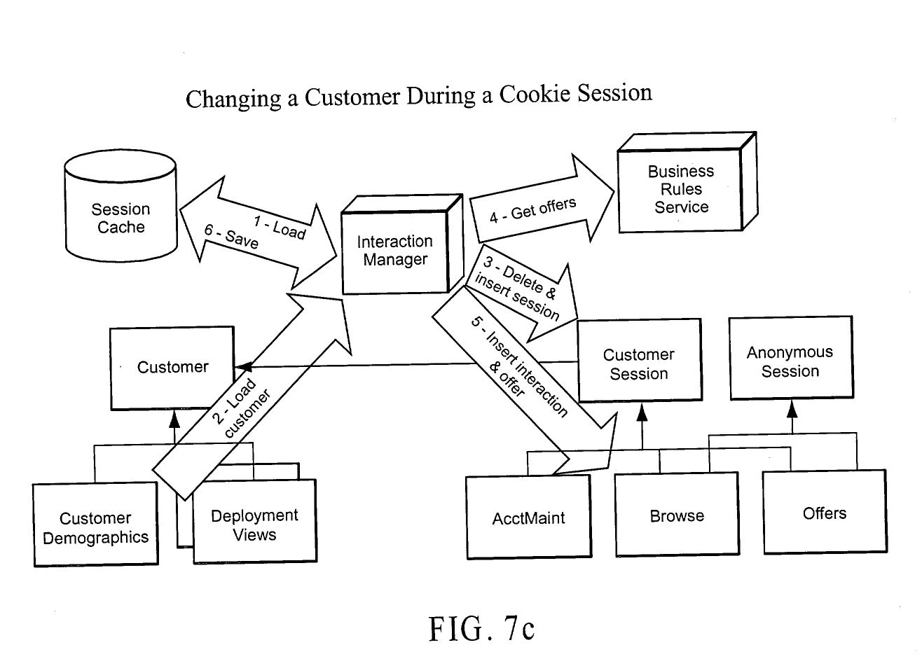

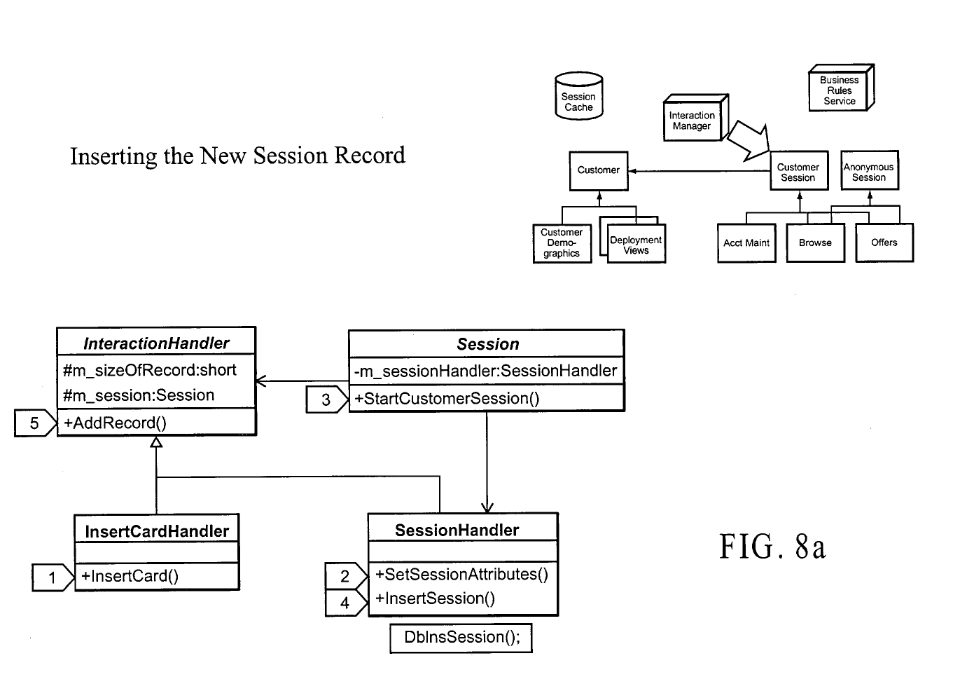

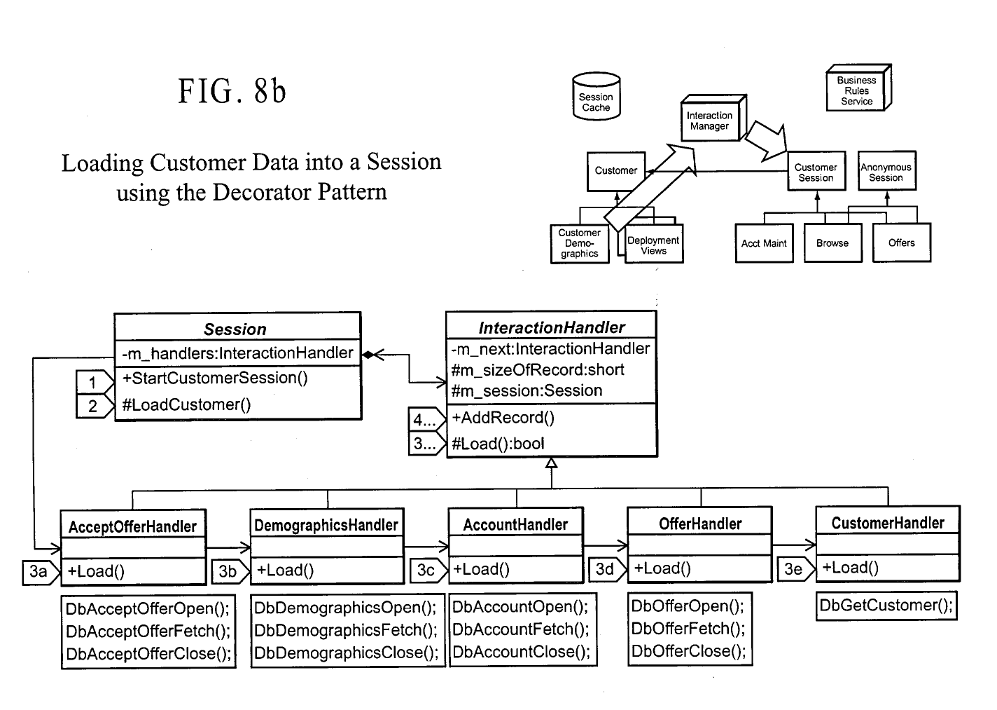

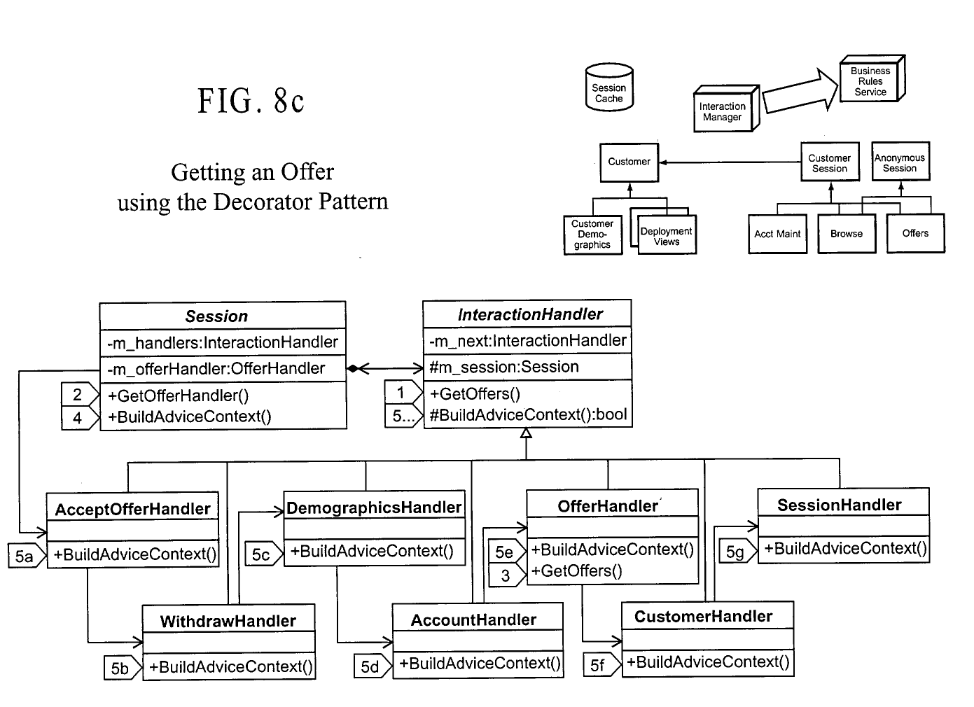

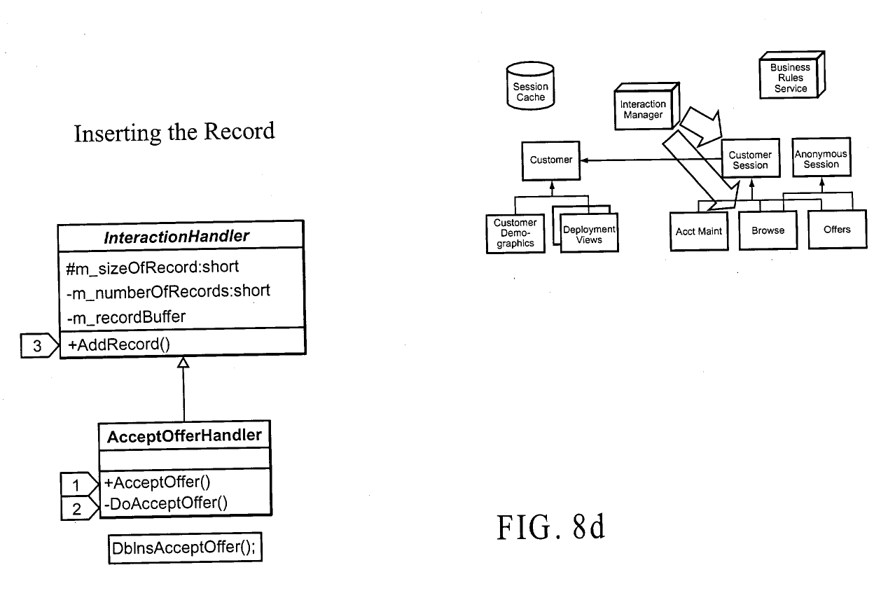

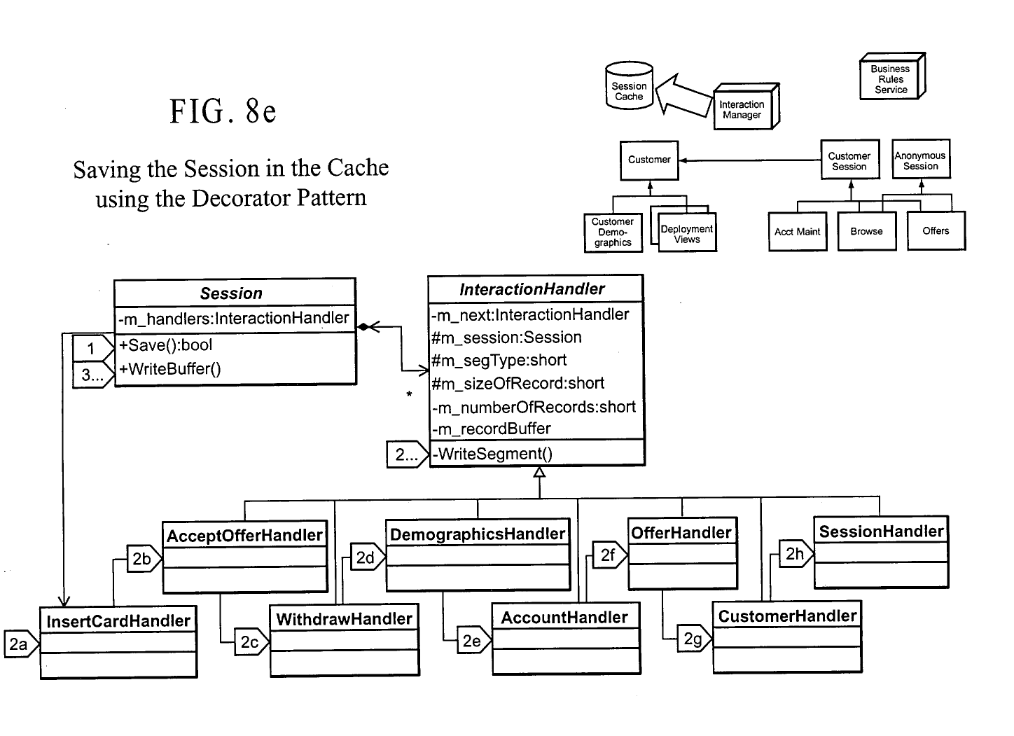

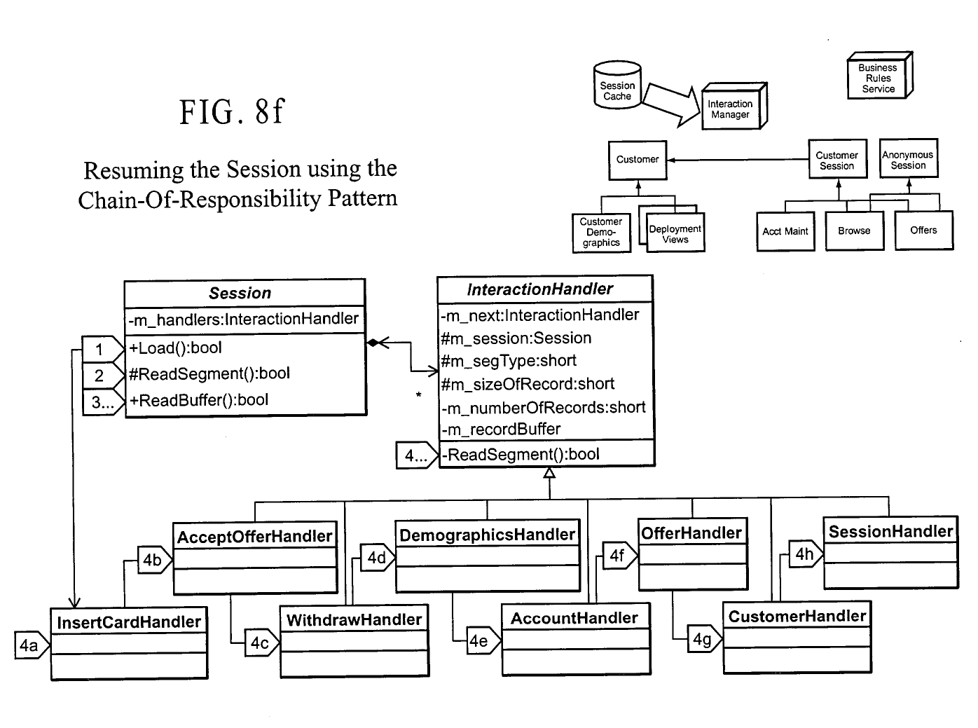

The IM provides a way of initiating and resuming sessions, each session consisting of one or more interactions (transactions). FIGS. 7a-c, show the flow of information during a session under the control of the IM. FIGS. 8a-f, illustrate the class framework for the IM handling of session records, customer data loading, getting offers and resuming sessions. As illustrated, the IM provides mechanisms for loading customer-related data at the beginning of a session, for caching session context (including customer data) after each interaction, for restoring session context at the beginning of each interaction and for forwarding session and customer data to a business rules service in order to obtain recommendations or offers. The IM stores session context in a table (e.g., NonStop SQL table).

As a support for enterprise customers who access the ZLE server via the Internet, the IM provides a way of initiating and resuming sessions in which the guest may be completely anonymous or ambiguously identified. In this scenario, the interface to the IM is running under a web server. The interface might be a CGI program, a Java servlet, a Java Server Page, or an Active Server Page. (The Common Gateway Interface (CGI), for example, is a standard for interfacing external applications with information servers, such as HTTP or Web servers. A CGI program is executed in real-time so that it can output dynamic information.) For each customer that visits the enterprise web site, the interface program assigns a unique cookie and stores it on the enterprise customer's computer for future reference. If a customer has merely visited but has never registered at the enterprise web site or electronically purchased anything from the enterprise, that customer is anonymous. Using that customer's cookie, an indication of the customer's prior visit, the IM can find a record of that customer's previous interactions (even though the customer is otherwise anonymous). If, for example, a customer registers at the enterprise web site via its home computer and in subsequent sessions uses the same computer the IM then associates the subsequent sessions with that customer. If the customer visits the enterprise web site via a different computer, say an office computer, the IM does not associate the new cookie with that customer. Unless and until the customer again signs in, the customer is considered anonymous as far as the IM is concerned. Once the customer signs in (identifies herself) the IM associates both computers (i.e., both cookies) with that customer. If someone other than this particular customer uses the same home and/or office computer to also register at the enterprise web site, the IM notes that several customers share the home and/or office computer (i.e., share the same cookie(s)).

Getting back to the more general scenario to explain the core functionality of the IM, we start from the point where an interaction initiates a new session (as shown in FIGS. 7a-c and 8a-f). When indicia of this interaction (event) is detected, the IM creates a (new) session record. Assuming that this record identifies the customer, the IM loads (subscribes to) corresponding customer data from the various customer tables in the ODS (e.g., demographics, insurance policy, previous accepted offers or other tables). If this record does not identify the customer it is a cookie operation and the IM does not load customer data. Instead, the IM creates (publishes) an anonymous session record. Next, the IM calls the rules service passing data to it from yet another table as well as the previous-offers table so that it can form a new offer. The IM inserts the interaction as well as the new offer(s) in a table. Having a pointer to the collection of tables, the IM can combine customer response information. The IM then saves everything about this interaction in the session cache (ODS). At that point, the IM sends the response to the customer (completing the interaction).

When a subsequent interaction is detected we assume that it belongs to the current session. Having saved the previous interaction and customer data for that session in the cache, the IM need not load the customer-related data again from the tables, as it is available in the cache (See: FIG. 7b). Thus, the IM loads the information it needs from the session cache. Namely, after the first interaction, the IM need not re-read the customer tables again because anything that it read out of these tables when the session started, as well as any new interactions that occurred during that session, are in the session cache.

The session cache is actually another table in the ODS. As will be later explained in more detail, the data the IM retrieved from the normalized tables in the ODS, is crammed into one table record, i.e., it is denormalized. By using the new approach of caching the interaction information, the IM saves a read step on subsequent interactions and is able to support the customer interactions based on cookies. Moreover, the IM is able to forward the customer data as well as information of previous interaction(s) in this session to the rules service and get a more suitable offer in response. Accordingly, the IM is optimized by this design.

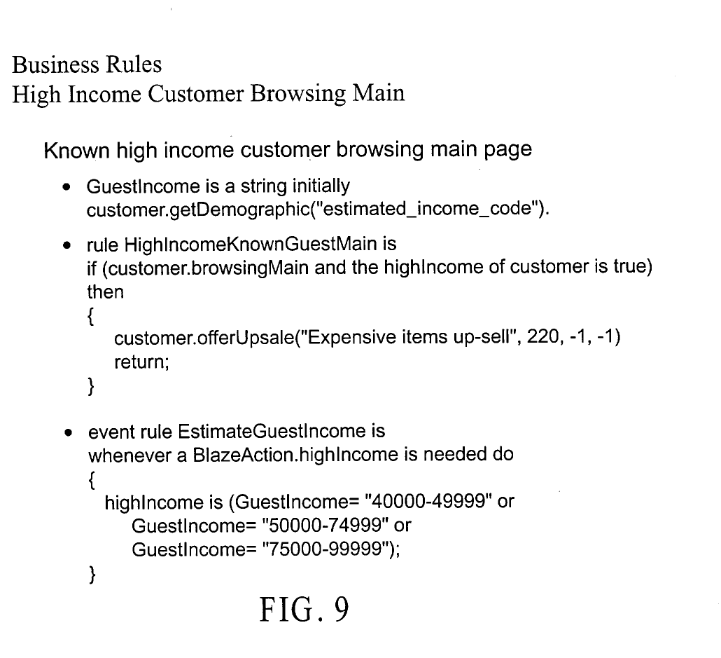

To further illustrate the functionality of an IM, an actual example of session management is presented. Initially, the enterprise does not know J. Doe, the customer. J. Doe clicks on the web site and since there is no known information about her, the IM offers her in response a default assortment of items. On establishing the session, a cookie is associated with J. Doe's computer. Later, J. Doe comes back to the ‘e-store’ (e.g., web site) and the enterprise still does not know who she is. However, from her cookie it is recognized that she has previously browsed the e-store and it is known where and on what she clicked. This time, the IM brings up (offers) items customized to J. Doe (assuming that she is interested in the same line of the items she clicked on before). Then, assuming that she goes and buys something J. Doe has to identify herself. At that point the IM can associate the cookie with J. Doe (for future interactions and sessions). Moreover, with the knowledge of J. Doe's identity, the IM goes to retrieve more information about her. For example, the IM can find out J. Doe's income bracket from Axiom (demographic information). Based on that information, as the example in FIG. 9 shows, the IM can tailor what it presents (offers) to J. Doe. (The assumption is that she is registering on the web site. Only then the IM can get a connection through her cookie, otherwise the IM will have two separate identifications. If she just mailed in a registration card, the IM does not have any way of associating her with the cookie.)

The ODS recalls all the information about J. Doe some of which comes from the applications feeding into the hub (including ODS) and some of which is the actual interactions captured by the IM. The IM is managing both kinds of data: data that came from somewhere else and data that the IM itself has captured, the actual interactions. The IM feeds this information to the business rules service that, in turn, applies business rules to it and recommends the offers that are made to the customer (J. Doe). Namely, the IM captures the interactions, gathers customer data that came from back-end systems, and calls the rules service and obtains an offer. There are rules that get for example the demographic information, and then there are cascading rules, called event rules, that are triggered based upon that demographic information (e.g., income). These are cascading events in that they are triggered from a previous event, e.g., the initial event.

B. Sessions

In managing enterprise customer interactions the IM governs sessions where, by and large, each session consists of a sequence of interactions (transactions) on behalf of a particular customer. Certain types of interaction always initiate a new session and indirectly they cause a preceding session to end. Certain events such as timeout can also cause a session to end, but normally there are no specific types of interaction that are specifically directed to ending a session. An interaction presenting a new customer ID, e.g., insert card, is one type of interaction that automatically starts a new session, although it first causes the pre-existing session to end and its corresponding area in the session cache to be purged. In the ATM example, there is a special interaction type when a customer removes his card from the ATM that causes the session to close. In the context of eCRM, a cookie-related session ends on time out. In handling a new interaction, when the IM loads the pre-existing session the IM determines if that session is timed out and if it is the IM starts a new session.

Various embodiments are associated with various session types. A notable addition to the assortment of session types is the identified user session. This type of session is based on the finding that financial institutions (banks, etc.) prefer to deal with identified customers and not with anonymous customers. The identified user session includes providing some unique customer identification on the initial interaction (e.g., insert card) and then returning a session ID. Namely, the customer is always identified in the beginning of the identified user session. The IM uses that session ID in subsequent interactions, such as a withdrawal or deposit. The IM obtains the customer identification, and any other information it needs that is relevant such as the ID of the ATM whereat the customer is. This information is provided with the session ID. In a withdrawal interaction, the customer provides the session ID as well as how much they want to withdraw from savings or checking, and then the IM returns the results.

In a web-browsing context, there is a semi-anonymous session. While browsing, a customer clicks on items and each click is an interaction. On everything the customer clicked the IM receives the customer's cookie ID, as well as information about what the customer clicked on. With each click (or sequence of clicks) the IM returns a web page (with purchase offers) customized to that customer. If the customer buys an item (or service) on any of the web pages the customer provides a real identity that can then be matched with the customer's cookie. In future sessions the cookie will be associated with that customer identity.

Thus, of the possible session types there are three notable types. One is the identified user type in which the customer is always identified at the beginning of the session. A second is the semi-anonymous type in which the customer is identified in the middle of the session. The third the anonymous type in which the customer is not identified at all, even though there is a cookie associated with that customer.

A cookie is unique but it is not uniquely associated with that customer. This is because the cookie identifies a computer but more than one person can use the same computer. Moreover, a customer may use several distinct computers. Therefore, there could be multiple cookies associated with multiple customers. Namely, there are various states of a cookie. There is a ‘non-state’ when a cookie is never matched with a customer identity or is matched with a customer only when that customer bought something (and identified itself). Therefore we assume that all uses of that cookie were for that customer. There is an ‘ambiguous state’ where, using the same computer, two customers have each previously purchased something, so that there are two customers associated with the same cookie and subsequently somebody is logging on. This cookie state is possible even though both customers, having previously bought something, are known during that particular session. It is noted that other cookie-like forms of identification can be used, including gate passes, hotel room keys etc. A gate pass or a hotel room can be handed over to another person, the pass/key being an anonymous identification yet allowing access to its holder.

C. Interactions

As mentioned, a session consists of a sequence of interactions on behalf of a particular customer. There are various kinds of interactions that can occur within a session, including those that always start a session and those that (indirectly) end a session. For example, in an ATM session the insert card is one kind of interaction that starts a session (it is the actual recognition of the card being inserted into the ATM machine). Withdrawal, deposit, account balance query and cash transfer are other possible interactions in an ATM session. During a web browsing session (in the eCRM context), each click is an interaction.

ATM or eCRM interactions need the enterprise to supply means of identifying the customers to the respective sessions. For an ATM session, the ATM card number is the identification means. That customer identification (the card number), is not the actual customer ID which is stored in the ODS. Rather, there is a table in the ODS that associates that card number with a particular customer ID because there is more than one way to identify a customer. Namely, at the ATM the customer uses the ATM card as the form of identification and at the teller's desk the customer uses either the card or another form of identification such as account number. Subsequent ATM interactions (such as a cash withdrawal or balance query) pass the session ID back to the IM as part of the interactions. In the eCRM context, the interface to the IM is running under a web server and the interactions return a unique session identifier. When providing a cookie, the customer ID can be provided at the same time.

Incidentally, interactions can be initiated by a customer via a web click or by customer service agent who is entering the interactions while on the phone with the customer. What is important to keep in mind is that there are different semantics associated with each situation which are distinguished when the wizards are run during deployment of the IM (as will be later explained). Also there needs to be a time-out mechanism, where after a certain time a session is no longer active.

It is also noted that a session involves various kinds of events. An interaction is an event. It is not the only kind of event, but it is a particular kind of event. Events are discrete in that each event represents a discrete transaction and if the event is incorrect a subsequent event is invoked to reverse (or offset the result of) the incorrect event. For example, a credit event will be invoked to offset an incorrect debit event. The events are linked to each other via the session to which they pertain. Namely, the events are identified to the IM via the session ID.

An offer is another kind of event, viewed as a feedback or response to the interaction. Offers are based upon the data provided by the IM, including interaction data, or event data, previous offers and customer data. Offers received from the rules service are inserted into the offer table of the ODS, to establish a record of what offers were made, and are returned to the customer by the IM. An ‘accept offer’ interaction is another event. One way in which accept offer can work is the customer types in his phone number on the keypad and clicks accept offer. Then, the IM captures the phone number so that a sales agent can call the customer. It may have been an insurance policy or a direct deposit or something like that. In the ATM session context, an insert card event is followed by an offer event. However, not all interactions involve offers. For instance, a subsequent withdrawal or deposit event is followed by a result but no additional offer. Although it is a design choice, in one design results are combined into the corresponding interactions and stored as one event, but offers, if any, are stored in the ODS as a separate events.

D. Data Mining

As noted, the IM is responsible for capturing the interactions, but it receives the aggregates. The data preparation tool (e.g., Genus Mart Builder) is responsible for selectively gathering the interactions and customer information in the aggregates, both for the IM and for data mining. Once the IM receives all this information it forwards that information to the rules service. In addition to generating the aggregates, general behavior patterns can be found in data sets. This pattern information is important in that a customer with, for instance, certain demographics and pattern of prior interactions is likely to respond favorably to a particular offer. Behavior patterns are discovered through data mining and models produced therefrom are deployed to the ODS by a model deployment tool.

The behavior models are stored at the ODS for later access by applications such as a scoring service in association with the rules service. The scoring service is actually intended to work with SAS Institute's enterprise intelligence software. In the ZLE environment it is deployed along with the Blaze Business Rules so that aggregates gathered by the IM can be scored with the behavior models when forwarded to the rules service. A behavior model is used in fashioning an offer to the enterprise customers. Then, data mining is used to determine what patterns predict whether a customer would accept or not accept an offer. New customers that contact the enterprise are scored in, and customers to whom no offer was previously made a determination is made whether they are in the group that would likely accept or likely reject such offer. Those among them that are likely to accept the offer are scored such that the IM can appropriately forward the offer to such customers.

The behavior models are created by the data mining tool based on behavior patterns it discovers (See: FIG. 6). The business rules are different from the behavior models in that they are assertions in the form of pattern-oriented predictions (See, e.g., FIG. 9). For example, a business rule looking for a pattern in which X is true can assert that “Y is the case if X is true.” Business rules are often based on policy decisions such as “no offer of any accident insurance shall be made to anyone under the age of 25 that likes skiing,” and to that end the data mining tool is used to find who is accident prone. From the data mining a model emerges that is then used in deciding which customer should receive the accident insurance offer. This is not to say that behavior models are always followed as a prerequisite for making an offer. There may be policy decisions that force overwriting the behavior model or not pursuing the business model at all, regardless of whether a data mine has been used or not.

E. Caching Tables in the ODS

One of the notable features proposed by the present invention is the session cache in the ODS and the manner in which the IM uses this cache (as shown in FIGS. 7a-c and 8a-f). What is further notable is the manner in which the IM maps cookies in anonymous or ambiguous sessions. Additionally, the unique manner in which the IM gathers the information and forwards it to the rules service is a more effective way of scaling the business rules service (rather than requiring the business rules service to be a stateful service).

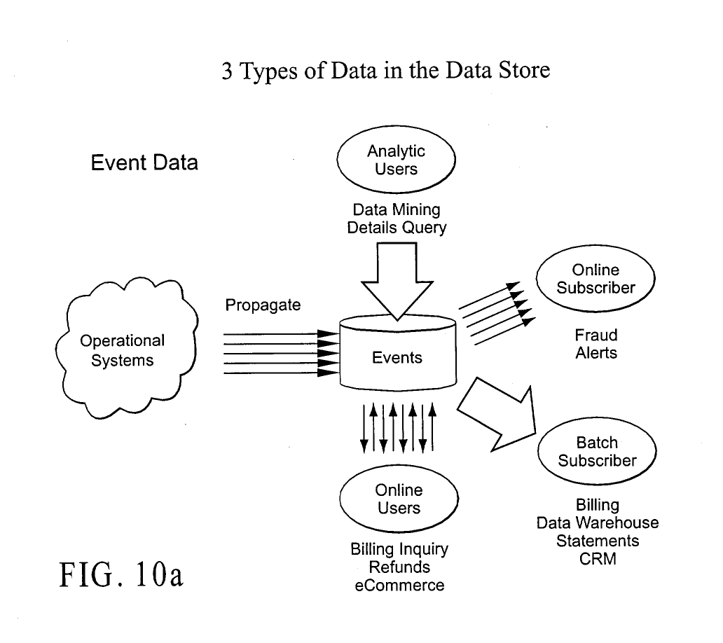

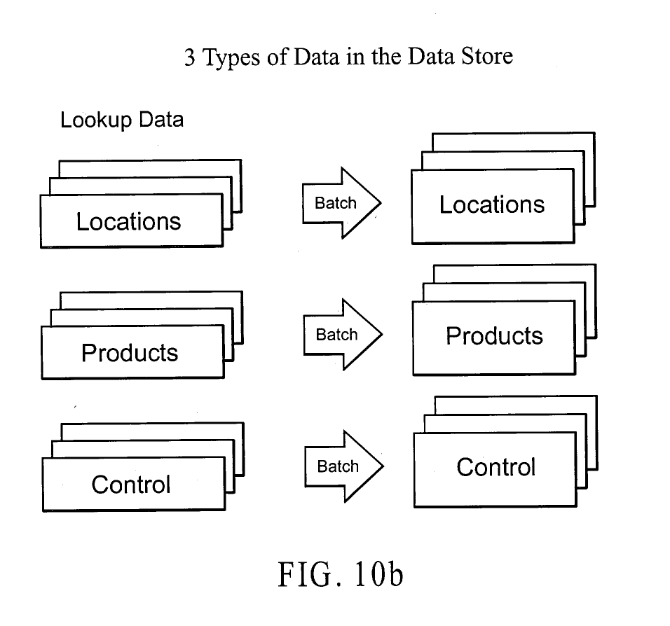

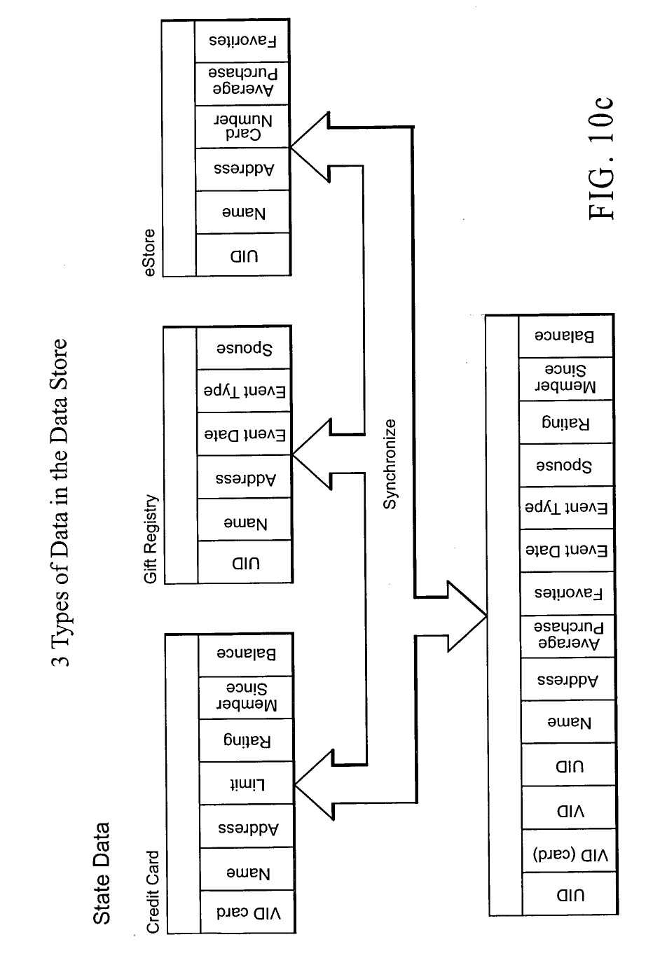

In view of that, three kinds of data are cached in the ODS: lookup data, event data and state data (FIGS. 10a-c). Lookup data contains information that is updated very infrequently (generally not in real time). Examples of lookup data include enterprise products catalog—e.g., the list of products or product part numbers—the location and identification of enterprise offices or stores, and like data. Lookup data is updated using typically a batch process (e.g., by uploading new products information into the product table once a week or even once a night).

Event data represent transaction data associated with events all through enterprise operations. Examples of events include the various aforementioned interactions, offers and more. As mentioned, events are discrete in that each event represents a discrete transaction and if an event is incorrect a subsequent event is invoked to reverse (or offset the result of) the incorrect event. The series of records for the events, including the records of incorrect and correct events, is captured by the IM and stored in the ODS. The records are linked to each other via the session to which they pertain, and they are identified to the IM with the session ID. In the ZLE infrastructure, event data publish and subscribe is real time focused.

State data is particularized to a customer and it includes data that can be updated while the customer is interacting with the enterprise. Examples of state data include the customer's (interaction) event date, credit balance, average purchase value, current address, etc.

Importantly, the traditional ODS would have state and lookup data, but it would not have the events. Hence, because the IM collects live events a traditional ODS would not involve an IM. By contrast, in the ZLE environment the IM interacts with the other ZLE components via the ODS.

For simplicity, a set of tables is grouped in the ODS (See: FIG. 6). For example, customer state data is contained in a group of tables that are particularized to the customer (i.e., customer oriented). Thus, the various customer tables are associated with the customer ID one way or another. Aggregates, another class of data grouped in tables, are event and state data combined. Aggregates represent a group of tables within the ODS that are different from the customer tables. The aggregates in the ODS and in the data mine are mirrored, i.e., are pretty much the same information. Tables that support cookies need not be customized, they are merely included or excluded from the ODS.

With regards to the ODS design for operation with the IM, it is advantageous to build a large ODS (with many disks) for handling massive amounts of data. Although it is not a prerequisite for building a ZLE infrastructure, embodiments with more than one (cluster) node (i.e., super clusters with 4, 8 or more nodes) advantageously provide the larger ODS.

F. Keys and Table Partitioning

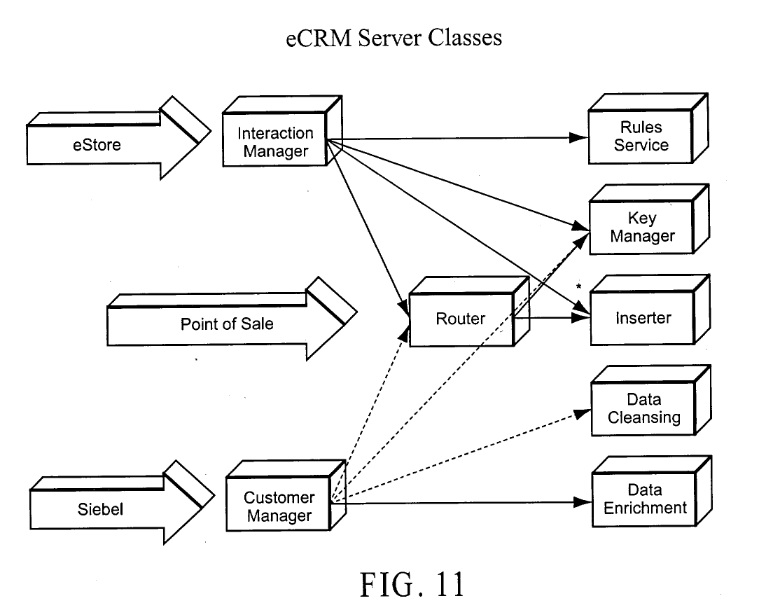

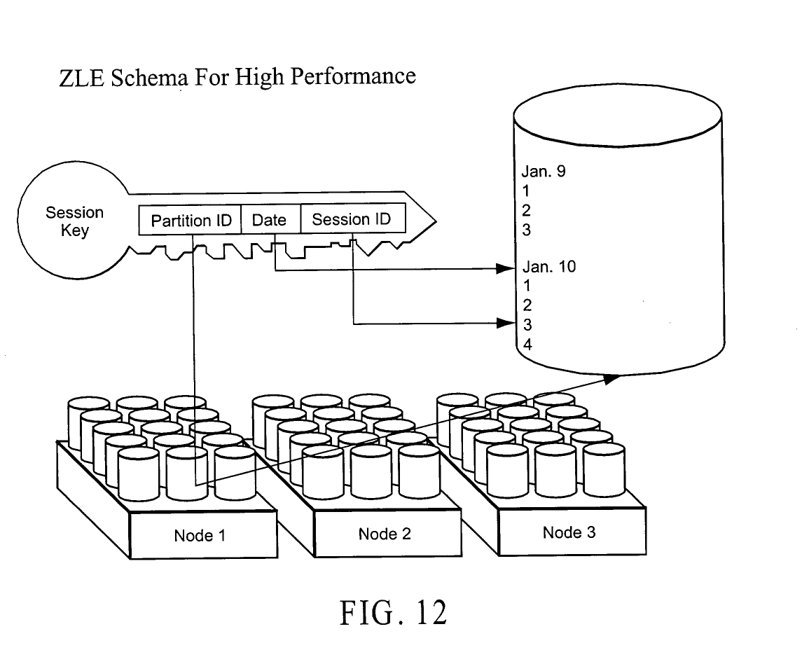

The key manager is used for assigning a key to each record (e.g., event records). FIG. 11 is a diagram showing deployment server classes including the IM and key manager for the eCRM example. The IM deployment template is predetermined subject to keys, event tables, interaction tables, etc., although later whatever business-specific attributes are needed they can be added to these tables. In each record, the key is a field that uniquely identifies that record and distinguishes it from all other records. As shown in FIG. 12, the keys are also used as means for controlling where on the disk, or disks, their respective records will be sited and for locating records on the disk. In one implementation, all the records are going to be stored in ascending primary key sequence. For example, record 0001 (with numeric primary key 0001) will be followed by record 1024, which will be followed by record 2015 and then record 3127.

In data processing systems the disk is typically a bottleneck in I/O (input/output) operations. For handling (reading/writing) large amounts of data it is more efficient to concurrently access multiple disks (by simultaneously moving their respective disk arms), retrieving from (or storing in) each disk a particular part of the data. Therefore, as to arrangement of the tables in the ODS the preferred method is partitioning (See: FIG. 12). Partitioning involves dividing the tables into partitions and distributing the partitions among the disks. Then, the individual partitions can be handled separately or in parallel. Preferably, tables are evenly partitioned where each partition is stored on a separate disk in order to provide better load balancing and faster response times. It is further preferred to evenly partition the individual tables over the same set of disks, so that each part of a table sits on a distinct disk in order to spread the data around.

An example illustrates the need for the foregoing load balancing approach. In this example, it is first assumed that there is a separate disk partition for every telephone area code. However, not all area codes have the same number of telephone numbers, and in that case, there is more data in some of these partitions and less data in others. Then, the disks end up with uneven amounts of data if each disk receives a single partition. The heavily loaded disks end up being really busy, while the others end up having nothing to do. For optimizing disk space and operations, it is therefore better to partition the tables (dividing each table's data) evenly across the disks so that all the disks are being utilized substantially at the same level.

To that end, partition identification (ID) is assigned to each partition and is made a part of the key (session key). In addition, the remainder of the key consists of the date and a session ID, which is an assigned number (See: FIG. 12). That number always increases. Because each partition resides on a distinct disk, the partition ID in effect identifies the physical disk that houses the partition. With each partition ID identifying its corresponding disk, new records can be appended to partitions. But records can be added only at the end of partitions since the records are arranged according to their ascending keys, incrementing session IDs and forward moving time. If, by comparison, a record were to be inserted in the middle of the partition, it would cause a split and unbalance the binary tree, so inserting in the middle is typically costly. Inserting records at the end is cheaper and faster and is more suitable for high volumes of inserts. Accordingly, in the preferred embodiment the tables are partitioned evenly so that even amounts of data are directed to each of the disks and records are always added at the ends of those partitions.

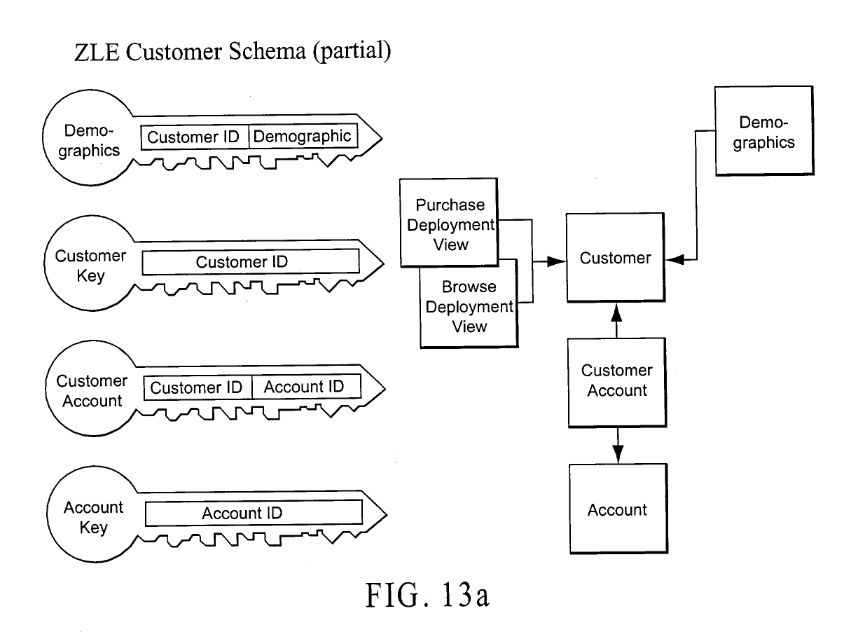

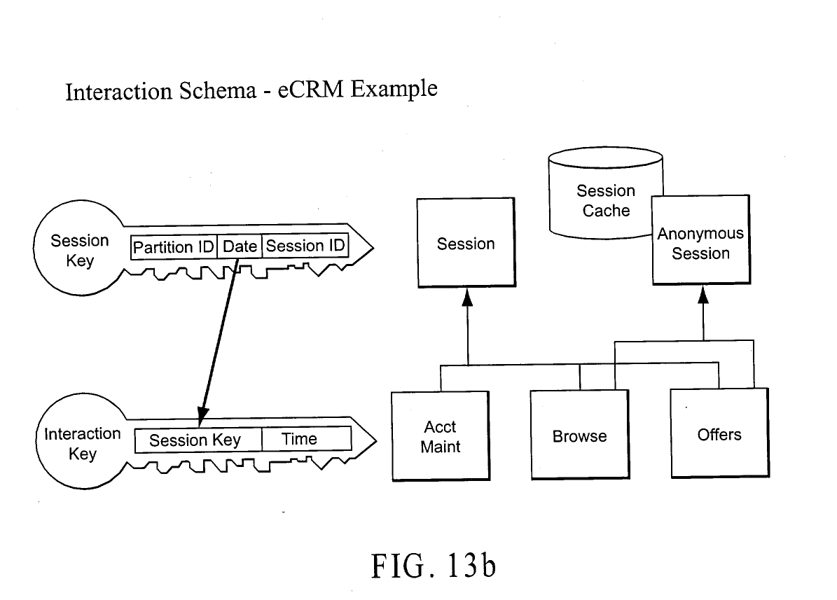

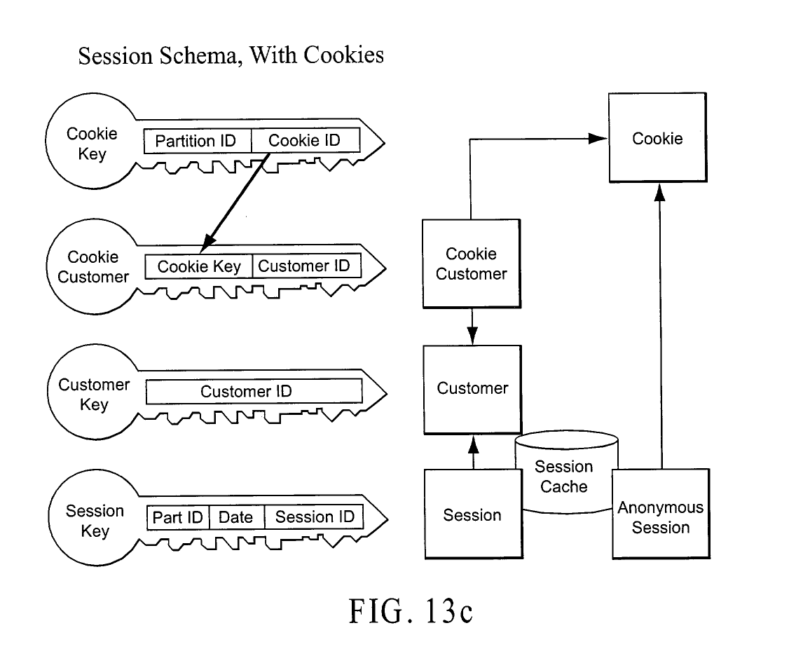

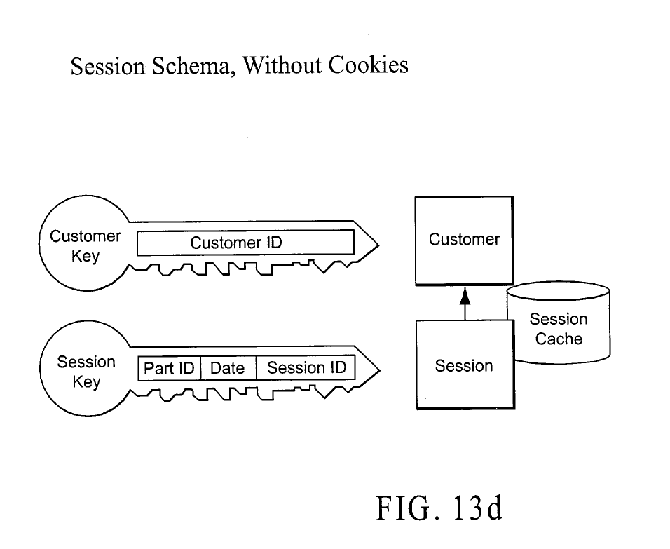

Of the session tables, one table holds the known sessions and one table holds the anonymous sessions. And then, the actual interactions are stored into a different table depending upon the type. FIG. 13a-d, show key management schemas for various table types. For example, the account maintenance interaction(s) would go into an account table, browser interaction(s) would go into a browser table and of course the offers are always inserted into yet another table. For web browsing, there are cookie tables that allow associating sessions with the cookies. More specifically, a session is actually associated to a customer and these tables are cookie-customer association tables. It is noted that the IM deployment template provides a way of omitting the cookie tables if on-line browsing is not supported or if on-line browsing mandates visitors to log in or register (i.e., identify themselves so that cookies are irrelevant).

Importantly, the tables are all partitioned the same way and are all keyed the same way, having the same kind of key. This key is the aforementioned (session) key plus a time stamp to make it unique because there are multiple interactions in a given session. Furthermore, each of these tables is evenly partitioned over the same number of disks such that each of the partitions from the group of tables that goes to a particular disk or set of disks shares the same partition ID.

G. Denormalized Cache

Before relational databases came into being, customer record format used to include a plurality of fields for a particular entry item (for example, three telephone number fields or five phone number fields in a single record). As long as a customer had no more telephone numbers than the number of available fields, all the customers' telephone numbers could be included. Moreover, the old format was unsuitable for writing a query because it didn't allow easy differentiation between or prioritization of the telephone number fields.

By comparison, with data organized in normalized form, instead of having a record with multiple fields (values or instances) for a particular entry item, there are multiple records each for a particular instance of the entry item. What is generally meant by normalized form is that different entities are stored in different tables and if entities have different occurrence patterns (or instances) they are stored in separate records rather than being embedded. One of the attributes of normal form is that there are no multi value dependencies (for example, a customer having more than one address or more than one telephone number are not located in a single record). Hence, for a customer with three different telephone numbers, there is a corresponding record (row) for each of the customer telephone numbers. These records can be distinguished and prioritized, but to retrieve all the telephone numbers for that customer, all three records are read from the customer table. In other words, the normalized table form is optimal for building queries. Accordingly, the database (in the ODS) is preferably designed to hold the data in normalized form as normalized tables support queries.

However, since the normalized form involves reading multiple records of the normalized table, it is not suitable for fast data access. The denormalized form is better for fast access, although denormalized data is not suitable for queries. And so the IM uses the denormalized data form in handing data to the rules service, though other applications are writing queries to the tables in normalized form.

Essentially, the IM takes the normalized data from the normalized tables and denormalizes it so that it can be put in the cache. The IM denormalizes it by taking this data and ‘craming’ it all together (as in a binary large object). Stated another way, the IM takes this data and lines it up flatly end-to-end forming one long record (serialized). For example, if in a session there are twenty offers, fifteen acceptances (serially) and five customer telephone numbers, the IM lays out (serially) the twenty offers, and then it lays out the fifteen acceptances followed by the five telephone numbers, etc. The length of the serialized record is theoretically unlimited (although there are physical limitations to account for). In a NonStop SQL configuration, there is a physical limit of 4K bytes to a record. In that case, the IM denormalizes the data and places it in the cache as one 4 k record or multiple 4K records. Along with the denormalized data, the record(s) in the cache contain a session ID key (for future association of the data with the particular session).

Then, when a new interaction prompts resumption of a session, the IM loads all its corresponding (denormalized) data from the cache and calls the rules service with that information. Once it gets the response (offer) from the rules service the IM inserts the response into the ODS and saves it back in the cache by writing over the old data. Essentially, the IM adds this interaction and offer, both being physically in the normalized table and in the cache (denormalized). For an anonymous session, the IM gets the interaction, unloads the previous session, and finds out whether the customer is purchasing anything and has previously given a customer ID. If so, the IM loads the customer information, wipes out the previous customer information from the cache and replaces it with the new customer information. The interactions that the IM loaded are still pertinent, but the customer information has been replaced. The IM deletes the old session record and puts in the new one. If it was an ambiguous customer, the IM might find two different customers associated with the cookie such that when the IM creates this session it gets two customer session records, one for each of the customers. Later on, the IM will know which of the two customers it is interacting with and delete the record for the other. Then the IM calls the rules service to get offers and insert the offers in the table and in the cache. At that point, the (denormalized) cache contains information of the new customer and all the interactions for the current session ready for fast access in a subsequent interaction for that session.

In summary, the IM is a clip-on application in a framework that enables the enterprise to integrate its services, applications and data in real time and provides for the maintenance of a comprehensive real-time view of enterprise operations and information. On this platform, the IM is designed for gathering information associated with customer interactions and for enriching those interactions with offers based upon the comprehensive real-time view of customer information, augmented by business rules and/or data mining. The IM utilizes data caching for more efficient customer-interaction data retrieval and processing. In addition to providing mechanisms for loading customer-related data at the beginning of each session, the IM provides mechanism for caching session context (including customer data) after each interaction and for restoring session context at the beginning of each interaction. What is more, the IM takes normalized data and denormalizes it, caching it lined up flatly end-to-end to form one long (serialized) record, so that it can be quickly retrieved in subsequent interactions and forwarded to the rules service. Along with the denormalized data, each long record is cached containing a session ID key for easy association of the denormalized data with the particular session.

Although the present invention has been described in accordance with the embodiments shown, variations to the embodiments would be apparent to those skilled in the art and those variations would be within the scope and spirit of the present invention. Accordingly, it is intended that the specification and embodiments shown be considered as exemplary only, with a true scope of the invention being indicated by the following claims and equivalents.

What is claimed is:

1. A computer readable medium embodying an interaction manager (IM) program with instructions for causing a computer system to perform steps, comprising:
gathering information associated with customer interactions;
loading customer-related data at the beginning of each session;
enriching the customer interactions with offers from a rules service; and
performing data caching for more efficient customer interaction data retrieval and processing, including caching a session context with the gathered information and customer-related data after each interaction and restoring the session context at the beginning of each interaction.

2. A computer readable medium as in claim 1, wherein the offers are based on a comprehensive real-time view of the customer-related data and are augmented by rules and/or data mining.

3. A computer readable medium as in claim 2, wherein the rules include enterprise rules and policies.

4. A computer readable medium as in claim 1, wherein the IM program instructions for data caching cause the computer system to cache data in denormalized form, and wherein the instructions for creating the denormalized form take the data in the normalized form and cache it lined up flatly and serially, end-to-end, in a long record so that it can be quickly retrieved in subsequent interactions and forwarded to the rules service.

5. A computer readable medium as in claim 4, wherein the long record with the data in denormalized form is cached along with a session identification key for easy association of the data in the denormalized form with a particular session.

6. A computer readable medium as in claim 4, wherein the long record is divided into portions, and wherein the data in denormalized form within each portion of the long record is cached along with a session identification key for easy association of the data in the denormalized form with a particular session.

7. A system for providing interaction management, comprising:
means for gathering information associated with customer interactions;
means for loading customer-related data at the beginning of each session;
means for enriching the customer interactions with offers from a rules service; and
means for data caching, including means for caching a session context with the gathered information and customer-related data after each interaction and means for restoring the session context at the beginning of each interaction.

8. A system for providing the interaction management as in claim 7, wherein the offers are based on a comprehensive real-time view of the customer-related data and are augmented by rules and data mining.

9. A system for providing interaction management as in claim 8, wherein the rules include enterprise rules and policies.

10. A system for providing interaction management as in claim 7, wherein the means for data caching includes
means for caching the data in denormalized form by taking the data in the normalized form and caching it lined up flatly and serially, end-to-end, in a long record so that it can be quickly retrieved in subsequent interactions and forwarded to the rules service.

11. A system for providing interaction management as in claim 10, wherein the long record is divided into portions, and wherein the data in denormalized form within each portion of the long record is cached along with a session identification key for easy association of the data in the denormalized form with a particular session.

12. A system for providing interaction management as in claim 7, wherein the system is configured with a zero latency enterprise (ZLE) framework for enterprise-wide integration of enterprise processes, applications including an IM for the interaction management, data and services to allow real-time recognition of events and synchronization and routing of information related to such events across an enterprise.

13. A system for providing interaction management as in claim 12, wherein the system includes an operational data store (ODS) through which the IM interacts with other applications.

14. A method for management of interactions with an interaction manager (IM), comprising:
creating a session record for a session initiated by an interaction with a customer;
loading customer data from a corresponding table in an operational data store (ODS) if an identity of the customer is available for the interaction, the session record being fashioned as an anonymous session record if the customer identity is not available and instead a cookie identifies an anonymous customer;
passing to a rules service data related to the current and any former interaction associated with the customer when an offer is commensurate with the interaction;
inserting data related to the customer, interaction, and any offer from the rules service to each corresponding table in the ODS;
caching in the ODS the data related to the customer, interaction, and any offer;
providing to the customer the offer(s) if commensurate with the interaction; and
on any subsequent interaction of that session retrieving the cached data and any offers from the ODS, thereby avoiding the need to load data from the corresponding tables in the ODS.

15. A method as in claim 14, wherein if on any subsequent interaction of an anonymous session the customer provides the customer identity the method further comprises:
associating the cookie with the customer;
loading customer data from a corresponding table in the ODS, if the customer data is available;
passing to a rules service data related to the current and any former interaction associated with the customer when an offer is commensurate with the interaction;
inserting data related to the customer, interaction, and any offer from the rules service to each corresponding table in the ODS;
caching in the ODS the data related to the customer, interaction, and any offer; and
providing to the customer the offer(s) if commensurate with the interaction.

16. A method as in claim 14, wherein the data in each of the corresponding tables is in normalized form, and wherein the cached data is in denormalized form fashioned as a long record that is cached along with a session key for easier association of the data in the denormalized form with the session.

17. A method as in claim 16, wherein fashioning the long record includes taking the data in the normalized form and caching it lined up flatly and serially, end-to-end, so that it can be quickly retrieved in subsequent interactions and forwarded to the rules service.

18. A method as in claim 17, wherein the long record is divided into portions, and wherein the data in denormalized form within each portion of the long record is cached along with a session identification key for easy association of the portions with the session.

19. A method as in claim 14, wherein the ODS is configured as a plurality of storage devices, and wherein the corresponding tables are partitioned by dividing each table into partitions and distributing the partitions of each table among the storage devices, one partition for each storage device.

20. A method as in claim 19, wherein the corresponding tables are partitioned evenly so as to allow load balancing among the storage devices.

21. A method as in claim 19, wherein there is a partition ID associated with each partition identifying the storage device that houses that partition.

22. A method as in claim 21, wherein each created session record has a key with a number of fields, one field contains the partition ID of the partition to the end of which the created session record is appended, a second field contains session date and a third field contains session identification.

23. A method as in claim 22, wherein the session identification is a number assigned to each session in ascending order.

24. A method as in claim 14, wherein there is a corresponding table for anonymous sessions and another corresponding table for identified customer sessions.

25. A method as in claim 14, wherein there is a corresponding table for each type of interactions.

26. A system for providing interaction management, comprising:
an operational data store (ODS);
means for creating a session record for a session initiated by an interaction with a customer;
means for loading customer data from a corresponding table in the ODS if an identity of the customer is available for the interaction, the session record being fashioned as an anonymous session record if the customer identity is not available and instead a cookie identifies an anonymous customer;
means for passing to a rules service data related to the current and any former interaction associated with the customer when an offer is commensurate with the interaction;
means for inserting data related to the customer, interaction, and any offer from the rules service to each corresponding table in the ODS;
means for caching in the ODS the data related to the customer, interaction, and any offer;
means for providing to the customer the offer(s) if commensurate with the interaction; and
means for retrieving on any subsequent interaction the cached data and any offers from the ODS, thereby avoiding the need to load data from the corresponding tables in the ODS.

27. A system for providing interaction management as in claim 26, wherein if on any subsequent interaction of an anonymous session the customer provides the customer identity the system further comprises:
means for associating the cookie with the customer;
means for loading customer data from a corresponding table in the ODS, if the customer data is available;
means for passing to a rules service data related to the current and any former interaction associated with the customer when an offer is commensurate with the interaction;
means for inserting data related to the customer, interaction, and any offer from the rules service to each corresponding table in the ODS;
means for caching in the ODS the data related to the customer, interaction, and any offer; and
means for providing to the customer the offer(s) if commensurate with the interaction.

28. A system for providing interaction management as in claim 26, wherein the data in each of the corresponding tables is in normalized form, and wherein the cached data is in denormalized form fashioned as a long record that is cached along with a session key for easier association of the data in the denormalized form with the session.

29. A system for providing interaction management as in claim 28, wherein the means for caching the data includes means for fashioning the long record by taking the data in the normalized form and caching it lined up flatly and serially, end-to-end, so that it can be quickly retrieved in subsequent interactions and forwarded to the rules service.

30. A system for providing interaction management as in claim 29, wherein the long record is divided into portions, and wherein the data in denormalized form within each portion of the long record is cached along with a session identification key for easy association of the portions with the session.

31. A system for providing interaction management as in claim 26, wherein the ODS is configured as a plurality of storage devices, and wherein the system further comprises means for partitioning the corresponding tables by dividing each table into partitions and distributing the partitions of each table among the storage devices, one partition for each storage device.

32. A system for providing interaction management as in claim 31, wherein the corresponding tables are partitioned evenly so as to allow load balancing among the storage devices.

32. A system for providing interaction management as in claim 31, wherein there is a partition ID associated with each partition identifying the storage device that houses that partition.

33. A system for providing interaction management as in claim 32, wherein each created session record has a key with a number of fields, one field contains the partition ID of the partition to the end of which the created session record is appended, a second field contains session date and a third field contains session identification.

34. A system for providing interaction management as in claim 33, wherein the session identification is a number assigned to each session in ascending order.

35. A system for providing interaction management as in claim 26, wherein there is a corresponding table for anonymous sessions and another corresponding table for identified customer sessions.

36. A system for providing interaction management as in claim 26, wherein there is a corresponding table for each type of interactions.

37. A system for providing interaction management as in claim 26, wherein the system is configured with a zero latency enterprise (ZLE) framework for enterprise-wide integration of enterprise processes, applications including an IM for the interaction management, data and services to allow real-time recognition of events and synchronization and routing of information related to such events across an enterprise.

38. A system for providing interaction management as in claim 26, wherein the system includes an operational data store (ODS) through which the IM interacts with other applications.

39. A method for interaction management, comprising:
gathering information associated with customer interactions;
loading customer-related data at the beginning of each session; 5 enriching the customer interactions with offers from a rules service; and
performing data caching for more efficient customer interaction data retrieval and processing, including caching a session context with the gathered information and customer-related data after each interaction and restoring the session context at the beginning of each interaction.

40. A method for interaction management as in claim 39, wherein the offers are based on a comprehensive real-time view of the customer-related data and are augmented by rules and/or data mining.

41. A method for interaction management as in claim 40, wherein the rules include enterprise rules and/or policies.

42. A method for interaction management as in claim 39, wherein the data caching includes saving data in denormalized form, and wherein the denormalized form is fashioned by taking the data in the normalized form and caching it lined up flatly and serially, end-to-end, in a long record so that it can be quickly retrieved in subsequent interactions and forwarded to the rules service.

43. A method for interaction management as in claim 42, wherein the long record with the data in denormalized form is cached along with a session identification key for easy association of the data in the denormalized form with a particular session.

44. A method for interaction management as in claim 42, wherein the long record is divided into portions, and wherein the data in denormalized form within each portion of the long record is cached along with a session identification key for easy association of the data in the denormalized form with a particular session.

45. An interaction manager, comprising:
means for gathering information associated with customer interactions;
means for loading customer-related data at the beginning of each session;
means for enriching the customer interactions with offers from a rules service; and
means for performing data caching for more efficient customer interaction data retrieval and processing, including caching a session context with the gathered information and customer-related data after each interaction and restoring the session context at the beginning of each interaction.

46. An interaction manager as in claim 45 deployed in a zero latency enterprise (ZLE) infrastructure with a rules engine for facilitating the rules service, and wherein the means for enriching the customer interactions includes means for leveraging a rules engine to define rules governing customer interactions throughout the enterprise.

47. An interaction manager as in claim 45 providing for a real-time insertion and tracking of customer interactions as they occur throughout the enterprise, so as to enrich the customer interactions based on real-time information made available anywhere across the enterprise.

48. An interaction manager as in claim 45 deployed in a zero latency enterprise (ZLE) infrastructure with an operational data store (ODS) through which the interaction manager interacts with components of the ZLE infrastructure.

49. An interaction manager as in claim 45 providing for initiating and resumption of sessions which include an interaction or a series of interactions, wherein if anonymous browsing is supported a guest is identified during an interaction via a cookie such that the interaction manager uses the cookie in subsequent interactions for finding a record of that guest's prior interactions and/or for mapping the record to an actual identity if the guest provides it.

50. An interaction manager as in claim 45, wherein information related to the customer interactions is cached in the ODS in denormalized form.
